(19) United States
(12) Patent Application Publication
(10) Pub. No.: US 2013/0178257 A1
(43) Pub. Date: Jul. 11, 2013

(54) SYSTEM AND METHOD FOR INTERACTING WITH VIRTUAL OBJECTS IN AUGMENTED REALITIES

(71) Applicant: Justin Langseth, Great Falls, VA (US)

(72) Inventor: Justin Langseth, Great Falls, VA (US)

(73) Assignee: Augaroo, Inc., Great Falls, VA (US)

(21) Appl. No.: 13/345,189

(22) Filed: Jan. 6, 2012

(51) Int. Cl. A63F 9/24; G06T 15/00; G09G 5/00

(52) U.S. Cl. 463/4; 345/633; 345/419

(57) ABSTRACT

The system and method described herein may be used to interact with virtual objects in augmented realities. In particular, the system and method described herein may include an augmented reality server to host software that supports interaction with virtual objects in augmented realities on a mobile device through an augmented reality application. For example, the augmented reality application may be used to create and deploy virtual objects having custom designs and embedded content that can be shared with other users to any suitable location, similarly interact with virtual objects and embedded content that other users created and deployed using the augmented reality application, participate in games that involve interacting with the virtual objects, obtain incentives and targeted advertisements associated with the virtual objects, and engage in social networking to stay in touch with friends or meet new people via interaction with the virtual objects, among other things.

### FIELD OF THE INVENTION

The invention generally relates to a system and method for interacting with virtual objects in augmented realities, and in particular, to enabling users to create and deploy virtual objects having custom visual designs and embedded content or other virtual items that can be shared with other users to any suitable location, interact with virtual objects and embedded content or other virtual items that other users created and deployed into certain locations, participate in treasure or scavenger hunts to locate and/or collect the virtual objects, obtain special offers, coupons, deals, incentives, and targeted advertisements associated with the virtual objects, play games that involve interaction with the virtual objects, and engage in social networking to stay in touch with friends or meet new people via interaction with the virtual objects, among other things.

### BACKGROUND OF THE INVENTION

Augmented reality generally refers to a field in computer technology that relates to combining computer-generated data and real-world data, which typically involves overlaying virtual imagery over real-world imagery. For example, many television sports broadcasts now incorporate augmented reality applications to superimpose or otherwise overlay virtual images over real-world game action to provide viewers additional information about the broadcast or otherwise enhance the viewer experience (e.g., football broadcasts often superimpose a virtual “first down” marker to show the distance that the offense has to cover to continue a current drive, baseball broadcasts often superimpose a virtual “strike zone” marker to indicate whether a certain pitch was a ball or strike, etc.). However, augmented reality systems have historically required substantial computing resources, a requirement which has interfered with the ability to deliver augmented reality applications to everyday users that would otherwise benefit from having virtual imagery provide to better interact with real-world environments. Further, developing augmented reality applications that the common consumer can use has tended to be restrained due to difficulties in suitably tracking user viewpoints that applications need to know in order to properly render virtual imagery based on where the user may be looking in the real-world.

More recently, substantial increases in the computing resources associated with many consumer electronics have brought about new opportunities to deliver augmented reality applications to everyday users. For example, common features in many (if not all) smartphones and computers available in the marketplace today include built-in cameras, video capabilities, location detection systems, high-resolution displays, and high-speed data access, among others. As such, many modern consumer electronics can now have capabilities that can suitably overlay virtual imagery over real-world imagery, which may support new tools to enhance how users experience physical reality. For example, using the built-in camera and the built-in location detection system on a mobile device to sense the viewpoint and physical location associated with a user, an augmented reality application may add virtual imagery associated with the sensed physical location to a display that represents the sensed viewpoint to visually represent additional information about the physical reality visible through the camera lens. Accordingly, augmented realities have significant potential to change how users view the real-world in many ways because augmented realities can show more information about user surroundings than would otherwise be available through the physical senses alone.

### SUMMARY OF THE INVENTION

According to one aspect of the invention, the system and method described herein may support interacting with virtual objects in augmented realities. In particular, the system and method described herein may generally host augmented reality software on an augmented reality server, which may support the interaction with the virtual objects in augmented realities on mobile devices (e.g., a smartphone, augmented reality glasses, augmented reality contact lenses, head-mounted displays, augmented realities directly tied to the human brain, etc.). In one implementation, the augmented reality interaction supported in the system and method described herein may generally enable users to create and deploy virtual objects having custom visual designs and embedded content or other virtual items that can be shared with other users to any suitable worldwide location, interact with virtual objects that other users created and deployed in addition to any content or other virtual items that may be embedded therein, participate in treasure hunts, scavenger hunts, or other interactive games that involve interaction with the virtual objects, obtain special offers, coupons, incentives, and targeted advertisements associated with the virtual objects or the interaction therewith, and engage in social networking to stay in touch with friends or meet new people via interaction with the virtual objects, among other things.

According to one aspect of the invention, to use the system and method described herein, a user associated with a mobile device may download an augmented reality application over a network from an application marketplace, wherein the augmented reality application may be free, associated with a one-time fee, or available on a subscription basis. Alternatively (and/or additionally), certain features associated with the augmented reality application may be free and the user may be required to pay to upgrade the augmented reality application or activate additional features associated therewith (e.g., a purchasing option in the augmented reality application may enable the user to buy virtual objects having certain types, buy certain designs that can be applied to the virtual objects, upload custom designs that can be applied thereto, etc.). In one implementation, the augmented reality server may therefore make the augmented reality application available to the mobile device via the application marketplace, which may share collected revenue associated with any fees charged to the user associated with the mobile device with an entity that provides the augmented reality server. Alternatively, in one implementation, the augmented reality server may make the augmented reality application directly available to the mobile device without employing the application marketplace to collect or otherwise charge any fees to the user associated with the mobile device. Moreover, in one implementation, one or more companies or other suitable entities may sponsor certain virtual objects for advertising or promotional purposes, in which case revenue associated therewith may be shared with or paid to the entity that provides the augmented reality server, used to reduce or eliminate fees that may be charged to the user, or otherwise customize certain features or contractual arrangements associated with the system.

According to one aspect of the invention, to support the augmented reality application, the mobile device may include a processor to execute the augmented reality application, location sensors to sense information relating to a current location, position, and/or orientation associated with the mobile device (e.g., a GPS sensor, compass, accelerometer, gyroscope), location data that relates to the current location, position, and/or orientation associated with the mobile device and other worldwide location-dependent information, a camera to sense a physical reality that represents a current viewpoint associated with the mobile device, and a user interface that shows the physical reality sensed with the camera and any virtual objects that may be present therein on a display. In one implementation, the physical reality that may be combined with virtual reality or virtual objects in any particular augmented reality described herein need not be limited to any particular geography, in that the physical reality may be on water, at a certain altitude in the air or above ground, or even in space, on the moon, on other planets, or any other location in the world or the universe to the extent that current or future technologies may permit sensing and tracking location information associated therewith. In addition, the mobile device may include one or more other applications functionality integrated with the augmented reality application (e.g., a social networking application that the augmented reality application may use to interact with other users). In one implementation, the mobile device may further include a database or another suitable repository that contains text, pictures, graphics, audio, video, icons, games, software, or other content or other virtual items that may be embedded in or otherwise associated with virtual objects that the user creates or interacts with via the augmented reality application, wherein content or other virtual items to embed in the virtual objects may be uploaded to the augmented reality server (e.g., to make the embedded content or other virtual items available to other users).

According to one aspect of the invention, the augmented reality server may include a processor, augmented reality software, and various databases or data repositories to support interaction with the virtual objects in the augmented realities via the augmented reality application installed on the mobile device, wherein the various databases or data repositories may contain user and mobile device data, virtual object content, incentive data, and advertising data. In particular, the augmented reality server may initially register the user associated with the augmented reality application in response to the augmented reality application having been installed on the mobile device and used to initiate communication with the augmented reality server, wherein registering the user may include the augmented reality server obtaining personal data associated with the user, identifying data associated with the mobile device, or any other information that may suitably relate to using the augmented reality application to access services, content, virtual items, or other data via the augmented reality server. As such, the augmented reality server may store the personal data associated with the registered user, the identifying data associated with the mobile device, and any other suitable information relating to the user and/or the mobile device in the user and mobile device data repository. In addition, the user may create a personal profile page associated with the augmented reality application and subsequently post, add, link, or otherwise submit information to customize the personal profile page, wherein the information associated therewith may be further stored in the user and mobile device data repository. In one implementation, additional information stored in the user and mobile device data repository may include payment information that the user submits to the augmented reality server, usage data associated with the augmented reality application, and records that relate to the location associated with the mobile device, among other things.

According to one aspect of the invention, the virtual object content may include content or other virtual items that the user submits in relation to virtual objects that the user created, collected, or otherwise interacted with via the augmented reality application. For example, the virtual object content may include any text, pictures, graphics, audio, video, icons, games, software, virtual currency, real currency that can be exchanged for actual cash or electronic credits, maps, offers, coupons, or other content or virtual items embedded in or otherwise associated with the virtual objects and any designs or other customizations that have been applied thereto. For example, the user may choose the design to apply to any particular virtual object from defaults available via the augmented reality application, upload a custom design to the augmented reality server, or take a picture to create the design to apply to the virtual object, and in each case the design chosen by the user may be applied to a surface associated with the virtual object (e.g., wrapped around a three-dimensional surface associated with the virtual object). In addition, the virtual object content may include data to represent the virtual objects that the user and/or other users have created and deployed into various worldwide locations, which may be associated with GPS coordinates, compass headings associated with rotational orientations, or other suitable location data that indicates the worldwide locations where the virtual objects have been deployed. In one implementation, the augmented reality server may dynamically update the GPS coordinates, compass headings, or other suitable location data associated with the virtual objects in response to one or more users finding and/or moving the virtual objects to a new location (i.e., to reflect the new locations where the virtual objects may have been moved).

According to one aspect of the invention, the incentive data may generally include content or other virtual items relating to deals, special offers, coupons, or other incentives that may be available to users associated with the augmented reality application. For example, various third-parties may submit the deals, special offers, coupons, or other incentives to the augmented reality server and specify certain locations where the deals, special offers, coupons, or other incentives may be available via the augmented reality application. Thus, in one implementation, the incentive content relating to the deals, special offers, coupons, or other incentives may be associated with virtual objects that can be found in the specified locations via the augmented reality application, and the augmented reality server may deliver the deals, special offers, coupons, or other incentives to the augmented reality application on the mobile device in response to the user finding and interacting with the associated virtual objects in the specified locations. In one implementation, the advertising data may similarly include advertisement content that third-parties submit to the augmented reality server, which may be delivered to the augmented reality application on the mobile device in a manner targeted to the user associated therewith (e.g., based on the personal data associated with the user, friends associated with the user, the identifying data associated with the mobile device, the location data associated with the mobile device, etc.). In one implementation, the advertising data may similarly be associated with virtual objects that can be found in certain locations, whereby the advertisements may be delivered to the augmented reality application in response to the user finding and interacting with the associated virtual objects. Alternatively (or additionally), the advertisements and the deals, special offers, coupons, or other incentives may not necessarily be associated with any particular virtual objects and instead delivered to the augmented reality application in response to certain conditions or criteria.

According to one aspect of the invention, in one implementation, the augmented reality server may therefore maintain and utilize the user and mobile device data, the virtual object content, the incentive data, and the advertising data to support interaction among the augmented reality application and other users associated with other mobile devices that have the augmented reality application installed thereon. For example, the user may grant the augmented reality application access to social networking or other third-party applications installed on the mobile device that relate to the other users or the other mobile devices, whereby the augmented reality application may access the social networking or other third-party applications to support the interaction among the augmented reality application and other users associated with other mobile devices that have the augmented reality application installed thereon. In addition, the augmented reality server may use the user and mobile device data, the virtual object content, the incentive data, and the advertising data to deliver information to the augmented reality application that relates to targeted advertisements, incentives, special offers, coupons, and new features associated with the augmented reality application. Furthermore, the augmented reality server may store cookies or other state data on the mobile device to preserve settings associated with the augmented reality application, or the user may have the option to disable or otherwise decline to store the cookies or other state data on the mobile device, in which case certain features associated with the augmented reality application that require the cookies or other state data may be disabled.

According to one aspect of the invention, in response to having registered the user associated with the augmented reality application and suitably populating the user and mobile device data, the virtual object content, the incentive data, and the advertising data, the augmented reality application may be used to interact with virtual objects in the augmented realities. For example, in one implementation, the location sensors associated with the mobile device may continuously obtain location data that represents the current location, position, and/or orientation associated with the mobile device, which the augmented reality application may continuously communicate to the augmented reality server. As such, the augmented reality server may use the current location data associated with the mobile device to derive real-world coordinates that represent the viewpoint associated with the camera on the mobile device. For example, in one implementation, the augmented reality server may use image registration, image recognition, visual odometry, or other suitable techniques to detect interest points, fiduciary markers, or optical flow information from the location data to detect real-world features that represent the viewpoint associated with the camera (e.g., corners, edges, or other real-world features in a scene that represents the camera viewpoint). The augmented reality server may then map geometry associated with the real-world features that represent the camera viewpoint to construct real-world coordinates that represent the scene corresponding to the camera viewpoint, which may be correlated to the coordinates associated with the virtual objects managed on the augmented reality server.

According to one aspect of the invention, in response to identifying any virtual objects in the virtual object content repository having coordinates that are present within the camera viewpoint, the augmented reality server may deliver the virtual object coordinates and any custom designs, embedded content or other virtual items, or other suitable data relating thereto to the augmented reality application on the mobile device, which may render the identified virtual objects on the user interface associated therewith in combination with the scene corresponding to the camera viewpoint. For example, the augmented reality application may cause the user interface to superimpose the virtual objects over a real-world image that represents the camera viewpoint, thereby generating an augmented reality that combines the virtual objects and the scene that represents the camera viewpoint. Further, as noted above, the augmented reality application may continuously communicate current location, position, and/or orientation data associated with the mobile device to the augmented reality server, which may use the current location, position, and/or orientation data to continuously derive, map, or otherwise determine the current viewpoint associated with the camera. As such, based on the current camera viewpoint, the augmented reality server may determine whether any virtual objects are present in the current camera viewpoint, whereby the augmented reality application on the mobile device may use data that the augmented reality server determines in relation thereto to continually refresh the augmented reality shown in the user interface to reflect movements or changes in the current camera viewpoint. For example, the augmented reality application may refresh the location in the augmented reality where the virtual objects exist to reflect the current viewpoint, remove the virtual objects from the augmented reality shown in the user interface if virtual objects that were previously displayed therein are no longer present in the current viewpoint, or otherwise refresh the augmented reality shown in the user interface based on any virtual objects that may or may not be present in the current camera viewpoint. Accordingly, the user may simply point the camera associated with the mobile device at real-world surroundings, and the augmented reality application may transparently communicate with the augmented reality server in a substantially continuous manner to refresh the augmented reality shown in the user interface to reflect whether or not any virtual objects are present in the surroundings where the camera currently points, and further to properly orient and re-orient the virtual objects with respect to distances, positions, and rotations associated therewith and/or other virtual objects relative to where the camera currently points in substantially real-time.

Other objects and advantages of the invention will be apparent to those skilled in the art based on the following drawings and detailed description.

### BRIEF DESCRIPTION OF THE DRAWINGS

FIG. 1 illustrates an exemplary system for interacting with virtual objects in augmented realities, according to one aspect of the invention.

FIGS. 2-9 illustrate exemplary user interfaces that may support interacting with virtual objects in augmented realities, according to various aspects of the invention.

### DETAILED DESCRIPTION

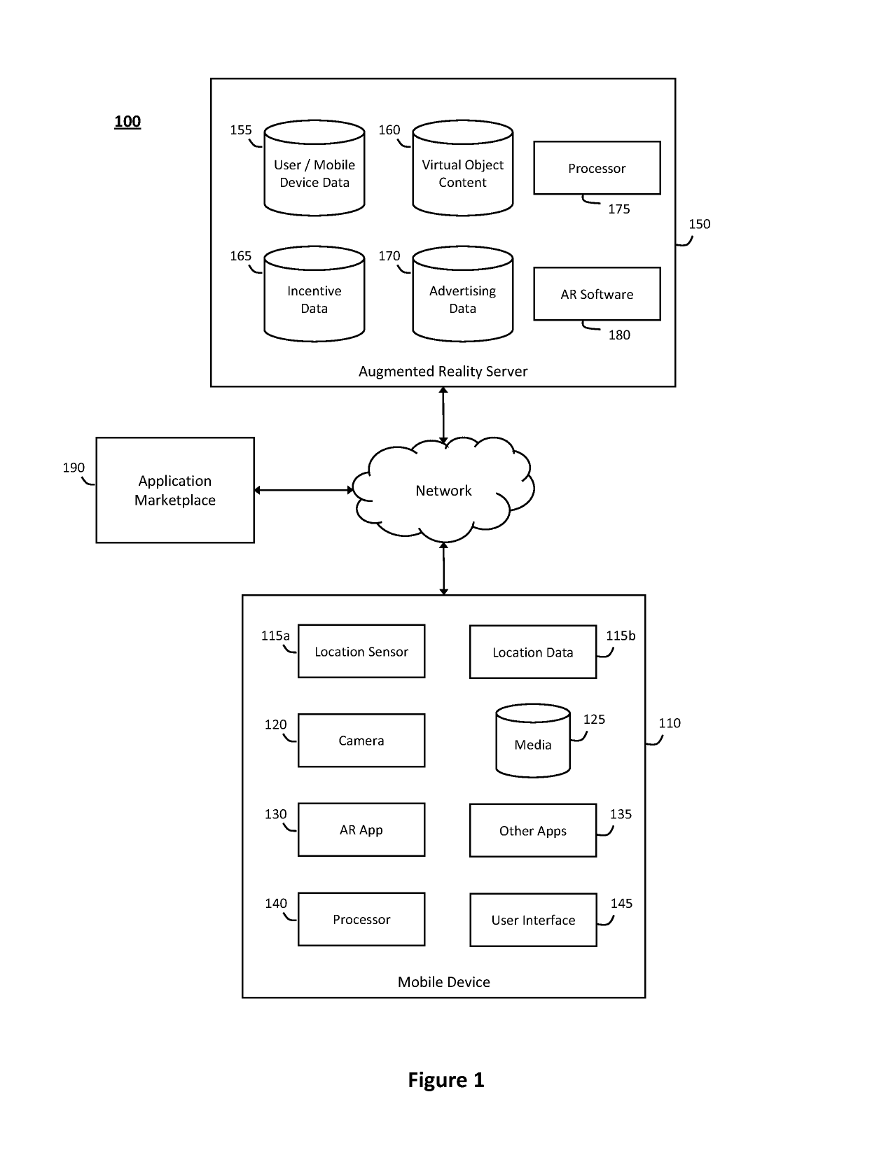

According to one aspect of the invention, FIG. 1 illustrates an exemplary system 100 for interacting with virtual objects in augmented realities. In particular, the system 100 shown in FIG. 1 may generally include an augmented reality server 150 that hosts augmented reality software 180 to support interaction with the virtual objects in augmented realities on a mobile device 110, which may include a smartphone, augmented reality glasses, augmented reality contact lenses, a head-mounted display, augmented realities directly tied to the human brain, or any other suitable computing device that can incorporate substantially similar components and capabilities to the mobile device 110 shown in FIG. 1 and described herein. In one implementation, as will be described in further detail herein, the augmented reality interaction that the system 100 supports may enable users to create virtual objects having custom visual designs, embed content or other virtual items into the virtual objects that can be shared with other users (e.g., text, photos, videos, etc.), deploy the virtual objects to any suitable worldwide location, interact with the virtual objects and embedded content or other virtual items that other users created and deployed into the world, participate in treasure or scavenger hunts to locate and/or collect virtual objects, obtain special offers, coupons, and other incentives associated with the virtual objects, play games that involve interacting with the virtual objects, and engage in social networking to stay in touch with friends or meet new people via interacting with the virtual objects, among other things.

In one implementation, in order to use the system 100 and interact with virtual objects in augmented realities, a user associated with the mobile device 110 may download an augmented reality application 130 over a network from an application marketplace 190 (e.g., iTunes, Android Market, etc.), wherein the augmented reality application 130 may be free, associated with a one-time fee, or available on a subscription basis. Furthermore, in one implementation, certain features associated with the augmented reality application 130 may be free and the user may be required to pay one or more fees to upgrade the augmented reality application 130 and activate one or more additional features (e.g., a purchasing option in the augmented reality application 130 may enable the user to buy virtual objects having certain types, buy certain designs that can be applied to the virtual objects, upload custom designs that can be applied thereto, etc.). In one implementation, the augmented reality server 150 may therefore make the augmented reality application 130 available to the mobile device 110 via the application marketplace 190, which may share collected revenue associated with any fees charged to the user associated with the mobile device 110 with an entity that provides the augmented reality server 150. Alternatively, in one implementation, the augmented reality server 150 may make the augmented reality application 130 directly available to the mobile device 110 without employing the application marketplace 190 to collect or otherwise charge any fees to the user associated with the mobile device 110. Moreover, in one implementation, one or more companies or other suitable entities may sponsor certain virtual objects for advertising or promotional purposes, in which case revenue associated therewith may be shared with or paid to the entity that provides the augmented reality server 150, used to reduce or eliminate fees that may be charged to the user, or otherwise customize certain features or contractual arrangements associated with the system 100.

In one implementation, to support executing the augmented reality application 130, the mobile device 110 may generally include a processor 140 to execute the augmented reality application 130, location sensors 115a (e.g., a GPS sensor, compass, accelerometer, gyroscope, etc.) to sense information relating to a current location, position, and/or orientation associated with the mobile device 110, location data 115b that relates to maps, points of interest, or other location-dependent information in any suitable worldwide location, a camera 120 to sense a physical reality that represents a current viewpoint associated with the mobile device 110, and a user interface 145 that shows the physical reality sensed with the camera 120 and any virtual objects that may be present therein on a display associated with the mobile device 110. In one implementation, the physical reality that may be combined with virtual reality or virtual objects in any particular augmented reality described herein need not be limited to any particular geography. As such, the augmented reality application 130 may be used to interact with virtual realities or virtual objects in physical realities located on water (e.g., in boats), in three-dimensions upward (e.g., at altitudes in the air or above ground using light aircraft, jetpacks, hang gliders, etc.), in three-dimensions downward (e.g., in underground caves, mines, etc.), or even in space, on the moon, on other planets, or any other location in the world or the universe to the extent that current or future technologies may permit sensing and tracking location information associated therewith. In addition, the mobile device 110 may include one or more other applications 135 functionality integrated with the augmented reality application 130. For example, the other applications 135 may include a social networking application that the augmented reality application 130 may use to interact with friends, contacts, or other users (e.g., notifying friends that the user associated with the mobile device 110 has created a virtual object to interact with, finding virtual objects that friends have created, etc.). In one implementation, the mobile device 110 may further include a database or repository containing media content 125, which may include text, pictures, graphics, audio, video, icons, games, software, or other content or virtual items that may be embedded in or associated with virtual objects that the user interacts with via the augmented reality application 130 (e.g., virtual objects that the user created via the augmented reality application 130, virtual objects created by other users via the augmented reality application 130 and subsequent found or collected by the user via the augmented reality application 130, etc.).

In one implementation, to support the augmented reality application 130 on the mobile device 110 interacting with the virtual objects in the augmented realities, the augmented reality server 150 may include various databases or repositories that contain user and mobile device data 155, virtual object content 160, incentive data 165, and advertising data 170, and may further include a processor 175 to execute the augmented reality software 180 hosted thereon and store, maintain, or otherwise utilize the user and mobile device data 155, the virtual object content 160, the incentive data 165, and the advertising data 170 contained in the repositories to support the augmented reality application 130.

In particular, in one implementation, the augmented reality server 150 may register the user associated with the augmented reality application 130 in response to the augmented reality application 130 having been installed on the mobile device 110 and used to initiate communication with the augmented reality server 150. For example, in one implementation, the augmented reality server 150 may obtain personal data associated with the user (e.g., a name, email address, phone number, birthday, etc.), identifying data associated with the mobile device 110 (e.g., a network address, operating system, browser, etc.), or any other suitable information that relates to using the augmented reality application 130 to access services, content, virtual items, or other data via the augmented reality server 150. As such, to register the user, the augmented reality server 150 may store the personal data associated with the user, the identifying data associated with the mobile device 110, and the other information relating to the user and/or the mobile device 110 in the user and mobile device data repository 160. Moreover, in one implementation, the user may create a personal profile page associated with the augmented reality application 130 and subsequently post, add, link, or otherwise submit information to customize the personal profile page, wherein the information associated with the personal profile page may be further stored in the user and mobile device data repository 160. In one implementation, additional information stored in the user and mobile device data repository 160 may include payment information that the user submits to the augmented reality server 150 (e.g., to purchase the augmented reality application 130, activate additional features associated therewith, etc.), usage data associated with the augmented reality application 130 (e.g., to measure how often users access certain features associated therewith), and records that relate to the location associated with the mobile device 110.

In one implementation, the virtual object content repository 160 may store content or other virtual items that the user submits or otherwise uploads in relation to virtual objects that the user created, collected, or otherwise interacted with via the augmented reality application 130. For example, the content or other virtual items stored in the virtual object content repository 160 may include any text, pictures, graphics, audio, video, icons, games, software, virtual currency, real currency that can be exchanged for actual cash or electronic credits, maps, offers, coupons, or other content or virtual items embedded in or otherwise associated with the virtual objects, and any designs or other customizations that have been applied to the virtual objects. For example, the user may choose the design to apply to any particular virtual object from defaults available via the augmented reality application 130, upload a custom design to the augmented reality server 150, or take a picture (e.g., with the camera 120) to create the design to apply to the virtual object, and in each case the design chosen by the user may be applied to a surface associated with the virtual object (e.g., wrapped around a three-dimensional surface associated with the virtual object). In one implementation, the content or other virtual items to embed in the virtual objects and information relating to the designs or other customizations applied to the virtual objects may be uploaded to the augmented reality server 150 and stored in the virtual object content repository 160 (e.g., to make the embedded content, virtual items, designs, and customizations available to other users that may interact with the virtual objects). Furthermore, in one implementation, the virtual objects that the user creates may be secured to restrict or otherwise control whether other users may be permitted to interact therewith (e.g., virtual objects may be secured to only be visible to the user that created the virtual objects, one or more users in a list defined by the user, certain friends or groups of friends defined in a social networking application 135, anyone, and/or users that have satisfy certain demographic, geographic, or other criteria. Moreover, in one implementation, the user may define criteria to specify how other users can interact with the virtual objects that the user creates (e.g., sorting the virtual objects according to popularity or distance from the other users, permitting the virtual objects to be viewed on a map, via the augmented reality corresponding to the viewpoint associated with the camera 120, and/or various suitable combinations thereof).

In addition, the virtual object content repository 160 may further include data to represent the virtual objects that the user and/or other users have created and deployed into various worldwide locations, wherein the virtual object content repository 160 may associate the virtual objects with GPS coordinates, compass headings associated with rotational orientations, or other suitable location data that indicates the worldwide locations where the virtual objects have been deployed. In one implementation, the processor 175 and the augmented reality software 180 associated with the augmented reality server 150 may dynamically update the GPS coordinates, compass headings, or other suitable location data associated with the virtual objects in the virtual object content repository 160 in response to one or more users finding and/or moving the virtual objects to a new location (i.e., to reflect the new locations where the virtual objects may have been moved).

In one implementation, the incentive data repository 165 may generally include content or other virtual items relating to deals, special offers, coupons, or other incentives that may be available to users associated with the augmented reality application 130. For example, various third-parties may submit the deals, special offers, coupons, or other incentives to the augmented reality server 150 and specify certain worldwide locations where the deals, special offers, coupons, or other incentives may be available via the augmented reality application 130. Thus, in one implementation, the incentive data repository 165 may associate the content or other virtual items relating to the deals, special offers, coupons, or other incentives with virtual objects that can be found in the specified locations via the augmented reality application 130, and the processor 175 and the augmented reality software 180 may deliver the deals, special offers, coupons, or other incentives to the augmented reality application 130 in response to the user finding and interacting with the associated virtual objects in the specified locations. In one implementation, the advertising data repository 170 may similarly include advertisement content that third-parties submit to the augmented reality server 150, which may be delivered to the augmented reality application 130 on the mobile device 110 in a manner targeted to the user associated therewith based on the personal data associated with the user, friends associated with the user, the identifying data associated with the mobile device 110, the records that relate to the location associated with the mobile device 110, behavior patterns associated with using the augmented reality application 130, or other suitable criteria. Furthermore, in one implementation, the advertising data repository 170 may similarly associate the advertisement content with virtual objects that can be found in certain locations, whereby the advertisements may be delivered to the augmented reality application 130 in response to the user finding and interacting with the associated virtual objects. Alternatively (or additionally), the advertisements and the deals, special offers, coupons, or other incentives may not necessarily be associated with any particular virtual objects and instead delivered to the augmented reality application 130 in response to certain conditions or criteria (e.g., a special offer or coupon may be delivered to a particular user that wins a treasure hunt, scavenger hunt, or other interactive game involving the virtual objects, advertisements may be delivered to mobile devices 110 in certain locations, etc.).

Accordingly, in one implementation, the augmented reality server 150 may maintain and utilize the user and mobile device data 155, the virtual object content 160, the incentive data 165, and the advertising data 170 contained in the repositories to support the augmented reality application 130 interacting with other users associated with other mobile devices 110 that have the augmented reality application 130 installed thereon (e.g., via granting the augmented reality application 130 access to social networking or other third-party applications 135 that relate to the other users or the other mobile devices 110), and further to provide customized content or other virtual items relating to advertisements, incentives, special offers, coupons, and new features associated with the augmented reality application 130 (e.g., based on the user and mobile data 155). Furthermore, in one implementation, the augmented reality server 150 may store one or more cookies or other state data on the mobile device 110 to preserve settings associated with the augmented reality application 130, although the user may have the option to disable or otherwise decline to store the cookies or other state data on the mobile device 110, in which case certain features associated with the augmented reality application 130 that require the cookies or other state data may be disabled.

In one implementation, in response to having registered the user associated with the augmented reality application 130, the augmented reality server 150 may execute the augmented reality software 180 to support interaction with the virtual objects in the augmented realities via the augmented reality application 130. For example, in one implementation, the location sensors 115a associated with the mobile device may continuously obtain the location data 115b that represents the current location, position, and/or orientation associated with the mobile device 110, wherein the augmented reality application 130 may continuously communicate the location data 115b that represents the current location, position, and/or orientation associated with the mobile device 110 to the augmented reality server 150. For example, in one implementation, the augmented reality application 130 and the augmented reality server 150 may generally use Comet or similar low-latency communication technology to manage the augmented realities. In particular, the augmented reality application 130 may open a persistent connection with the augmented reality server 150 to send and receive data relating to all events associated with the augmented realities, whereby the low-latency communication technology used in the system 100 may cause the augmented reality server 150 and the augmented reality application 130 to push the data relating to the events associated with the augmented realities to one another at any time without closing the persistent connection.

Accordingly, in one implementation, the low-latency communication technology may substantially reduce latencies between a time when the user takes certain actions with respect to the virtual objects or the augmented realities associated therewith and the time when the actions are reflected on the display associated with other users that may be interacting therewith (e.g., to a half-second or less). Furthermore, in one implementation, the augmented reality server 150 may use the low-latency communication technology to adjudicate situations in which multiple users trigger different actions on a particular virtual object at substantially the same time. For example, if the different actions are incompatible (e.g. because the multiple users moved the virtual object in opposite directions) the augmented reality server 150 may determine which action happened first, execute the action that happened first and discard any subsequent actions incompatible therewith, and then notify augmented reality applications 130 on the mobile devices 110 associated with any other users that triggered the subsequent incompatible actions. In one implementation, the augmented reality applications 130 associated with the other users may then update or otherwise correct the user interface 145 to properly reflect the action that happened first in lieu of the subsequent incompatible actions that the other users triggered (e.g., if the user interface 145 was updated to indicate that the subsequent action occurred, the augmented reality application 130 may update or otherwise correct the user interface 145 to undo the subsequent action even if the user interface 145 previously showed that the action was triggered). As such, in one implementation, the low-latency communication technology may result in the augmented reality server 150 delivering an event relating to the action that happened first to the augmented reality application 130, wherein the event may cause the augmented reality application 130 to update or otherwise correct the user interface 145 in approximately half a second (e.g., to reflect that the subsequent incompatible action was not triggered on the virtual object and that the first action initiated by the other user was triggered). In one implementation, further exemplary detail relating to the low-latency communication technology that may be used in the system may be provided in “Comet: Low Latency Data for the Browser,” the contents of which are hereby incorporated by reference in their entirety.

As such, in one implementation, the augmented reality server 150 may use the current location data 115b associated with the mobile device 110 to derive real-world coordinates that represent the viewpoint associated with the camera 120. For example, the augmented reality software 180 may use image registration, image recognition, visual odometry, or any other suitable technique to detect interest points, fiduciary markers, or optical flow information from the location data 115b, which may be used to detect real-world features that represent the viewpoint associated with the camera 120 (e.g., corners, edges, or other real-world features in a scene that represents the viewpoint associated with the camera 120). The augmented reality software 180 may then map geometry associated with the real-world features that represent the viewpoint associated with the camera 120 to construct real-world coordinates that represent the scene corresponding to the viewpoint, which may be correlated to the coordinates associated with the virtual objects in the virtual object content repository 155. While the above description provides exemplary techniques that may be used to map the viewpoint associated with the camera 120, other suitable techniques may be used, including those described in “Marker Tracking and HMD Calibration for a Video-based Augmented Reality Conferencing System,” the contents of which are hereby incorporated by reference in their entirety.

As such, in response to identifying any virtual objects in the virtual object content repository 155 having coordinates within the viewpoint associated with the camera 120, the augmented reality software 180 may deliver information relating to the coordinates, any custom designs, embedded content, virtual items, or other suitable data relating to the identified virtual objects to the augmented reality application 130, which may render the identified virtual objects on the user interface 145 associated with the mobile device 110 in combination with the scene corresponding to the viewpoint associated with the camera 120. For example, the augmented reality application 130 may superimpose the virtual objects displayed in the user interface 145 over a real-world image that represents the viewpoint associated with the camera 120 to generate an augmented reality that combines the virtual objects and scene that represents the viewpoint associated with the camera 120. Further, as noted above, the augmented reality application 130 may continuously communicate the current location, position, and/or orientation associated with the mobile device 110 to the augmented reality server 150 over the network, which the augmented reality software 180 hosted thereon may use to continuously derive, map, or otherwise determine the current viewpoint associated with the camera 120. As such, based on the current viewpoint associated with the camera 120, the augmented reality software 180 may determine whether any virtual objects are present in the current viewpoint associated with the camera 120, and the augmented reality application 130 may use data that the augmented reality server 150 delivers in relation thereto to continually refresh the user interface 145 to reflect movements or changes in the current viewpoint associated with the camera 120 in substantially real-time. For example, in one implementation, locations where the virtual objects are displayed in the user interface 145 may be refreshed to reflect the current viewpoint, remove the virtual objects from the user interface 145 if previously displayed virtual objects are no longer present in the current viewpoint, reflect movements associated with the camera 120, the virtual objects themselves, or combinations thereof, or otherwise reflect changes to the locations associated with the virtual objects and/or the current viewpoint in substantially real-time. For example, if a particular virtual object moves left and the camera 120 moves right, if multiple virtual objects move into the current viewpoint in different directions, or other changes to the locations associated with the virtual objects and/or the current viewpoint occur, the augmented reality server 150 and the augmented reality application 130 may cooperatively communicate to seamlessly handle refreshing the user interface 145 to reflect the virtual object and camera 120 movements or other changes to the locations associated therewith. Furthermore, in one implementation, the user may simultaneously view the virtual objects from different viewpoints (e.g., on a map, in a live viewpoint associated with the camera 120, etc.), and the augmented reality application 130 may automatically and substantially immediately update the view associated with the virtual objects to reflect any actions that other users may take to interact with the virtual objects that the user may be viewing. Accordingly, the user associated with the mobile device 110 may simply point the camera 120 at real-world surroundings, and the augmented reality application 130 may communicate with the augmented reality server 150 in a substantially continuous manner to refresh the user interface 145 based on whether or not any virtual objects are present in the surroundings where the camera 120 currently points, properly orient and re-orient the virtual objects with respect to distances, positions, and rotations associated therewith and/or other virtual objects relative to where the camera 120 currently points, or otherwise manage the virtual objects displayed in the user interface 145.

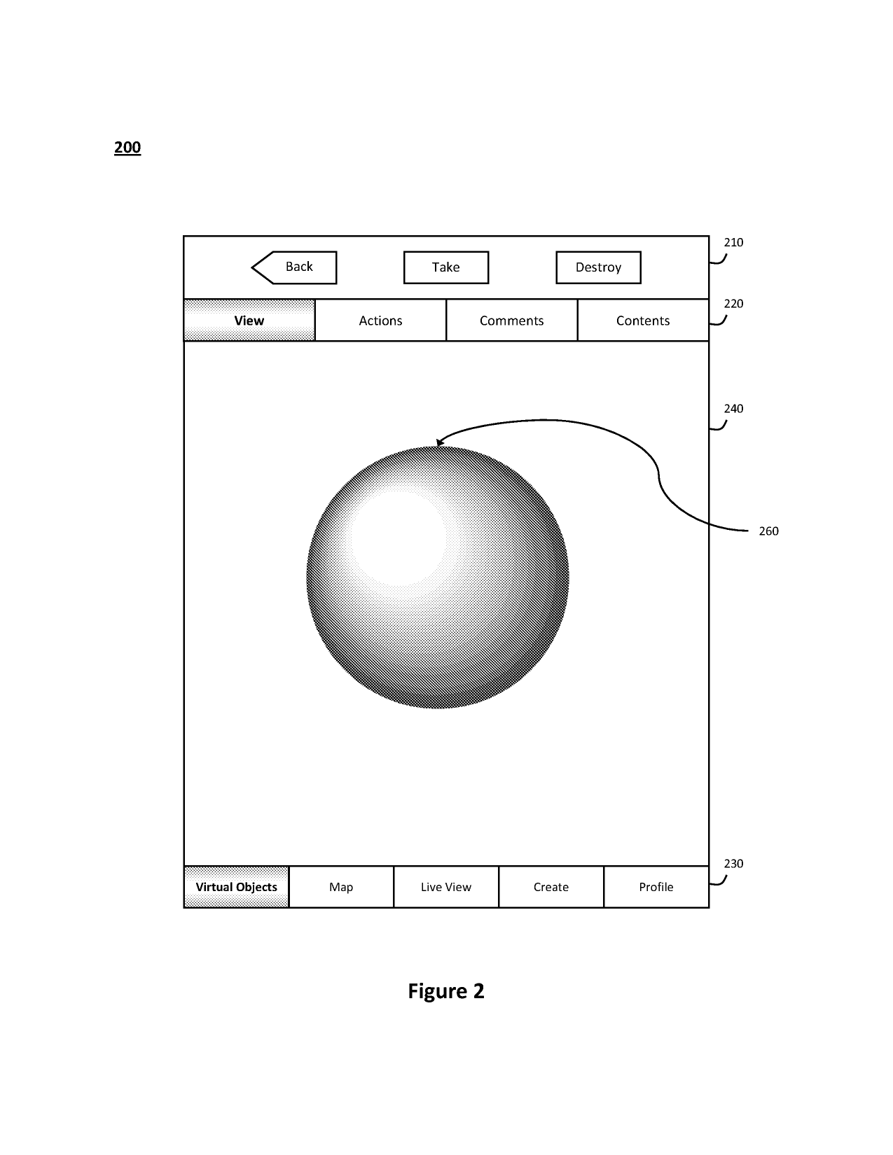

Having provided the above overview generally describing the architectural components and functionality associated with the system 100 that enables interaction with virtual objects in augmented realities, the following description relating to FIGS. 2-8 will more particularly describe various exemplary user interfaces and exemplary functionality associated with the processor 140 executing the augmented reality application 130 on the mobile device 110 support interacting with virtual objects in augmented realities.

For example, in one implementation, FIG. 2 illustrates an exemplary user interface 200 that may support interacting with virtual objects 260 in augmented realities. In particular, the user interface 200 shown in FIG. 2 may be displayed on a mobile device in response to a user loading an augmented reality application installed on the mobile device, wherein the loaded augmented reality application may then initiate communication with an augmented reality server that supports the augmented reality application to login to an account associated with the user and maintained at the augmented reality server. In one implementation, in response to suitably logging into the account associated with the user, the augmented reality server may identify any virtual objects 260 that the user has created with the augmented reality application, any virtual objects 260 created by other users that the user has collected or otherwise interacted with via the augmented reality application, and any other virtual objects 260 that may be associated with the user and/or nearby a location associated with the mobile device. In one implementation, the augmented reality server may then deliver data relating to the identified virtual objects 260 to the augmented reality application executing on the mobile device, which may then refresh the user interface 200 shown in FIG. 2 to display information relating to the identified virtual objects 260. More particularly, in one implementation, the augmented reality application may refresh the user interface 200 to show an augmented reality area 240 in which one or more virtual objects 260 may be displayed (e.g., the virtual objects 260 identified at the augmented reality server), wherein the virtual objects 260 may generally be represented with a sphere, cube, prism, cone, cylinder, pyramid, or another suitable three-dimensional shape. As such, the three-dimensional shape associated with the virtual objects 260 may allow the augmented reality area 240 to superimpose or otherwise overlay the virtual objects 260 over images in the augmented reality area 240 that represent three-dimensional physical realities (e.g., a current camera viewpoint, a map or satellite image representing a certain geographic area, etc.). Moreover, in one implementation, the three-dimensional shape associated with the virtual objects 260 may allow the user to walk around the virtual objects 260 or otherwise move the current camera viewpoint to view the virtual objects 260 (and any designs applied thereto) from various sides. In one implementation, however, the virtual objects 260 may be suitably represented with circles, squares, triangles, or other suitable two-dimensional shapes if the physical reality shown in the augmented reality area 240 has a two-dimensional representation (e.g., a two-dimensional map).

In one implementation, the user interface 200 may further include an interaction menu 210 that includes one or more navigation options to navigate the augmented reality application (e.g., a back button to return to a previous user interface) and one or more interaction options to interact with any virtual objects 260 that may be displayed in the augmented reality area 240. For example, in one implementation, the interaction options may include a take button to collect or otherwise interact with a virtual object 260 displayed in the augmented reality area 240, a destroy button to delete or otherwise discard a virtual object 260 displayed in the augmented reality area 240, or various other buttons that may be used to interact with the virtual objects 260 (e.g., an edit button to modify the virtual objects 260, an open button to view, see, or otherwise interact with content or virtual items embedded in the virtual objects 260, an add button to embed content or virtual items in the virtual objects 260, a move button to relocate the virtual objects 260 to another place, a pocket button to deliver or share the virtual objects 260 with another user, etc.). Furthermore, in one implementation, the user interface 200 may include a virtual object menu 220 having various options to manage virtual objects 260 associated with the user (e.g., the virtual objects 260 created by the user, collected virtual objects 260 that other users created, any virtual objects 260 shown in the augmented reality area 240, etc.). For example, in one implementation, the virtual object menu 220 may include a view option to view the virtual objects 260 within the augmented reality area 240, an actions option to take, collect, destroy, move, and/or otherwise interact with the virtual objects 260, a comments option to post and share comments relating to the virtual objects 260 with friends, contacts, or other users, and a contents option to view, embed, remove, or otherwise interact with text, pictures, graphics, audio, video, icons, games, software, or other content or virtual items associated with the virtual objects 260. Moreover, in one implementation, the user interface 200 may include a main menu 230 having various options to use the augmented reality application to interact with the virtual objects 260. For example, in one implementation, the main menu 230 may include a virtual objects option to display the virtual objects 260 associated with the user in the augmented reality area 240 (e.g., virtual objects 260 created by, collected by, shared with, or otherwise associated with the user), a map option to render or otherwise display a map in the augmented reality area 240 in addition to any virtual objects 260 present therein, a live view option to show a current camera viewpoint in the augmented reality area 240 and any virtual objects 260 present therein, a create option to design, develop, or otherwise create a new virtual object 260, and a profile option to create, update, edit, or otherwise modify a personal profile page associated with the user (e.g., to provide name, address, contact data, or other information associated with the user, update payment information needed to upgrade the augmented reality application, activate certain features, buy virtual objects 260 having certain types, buy certain designs that can be applied to the virtual objects 260, upload custom designs that can be applied thereto, post information to share with other users, etc.).

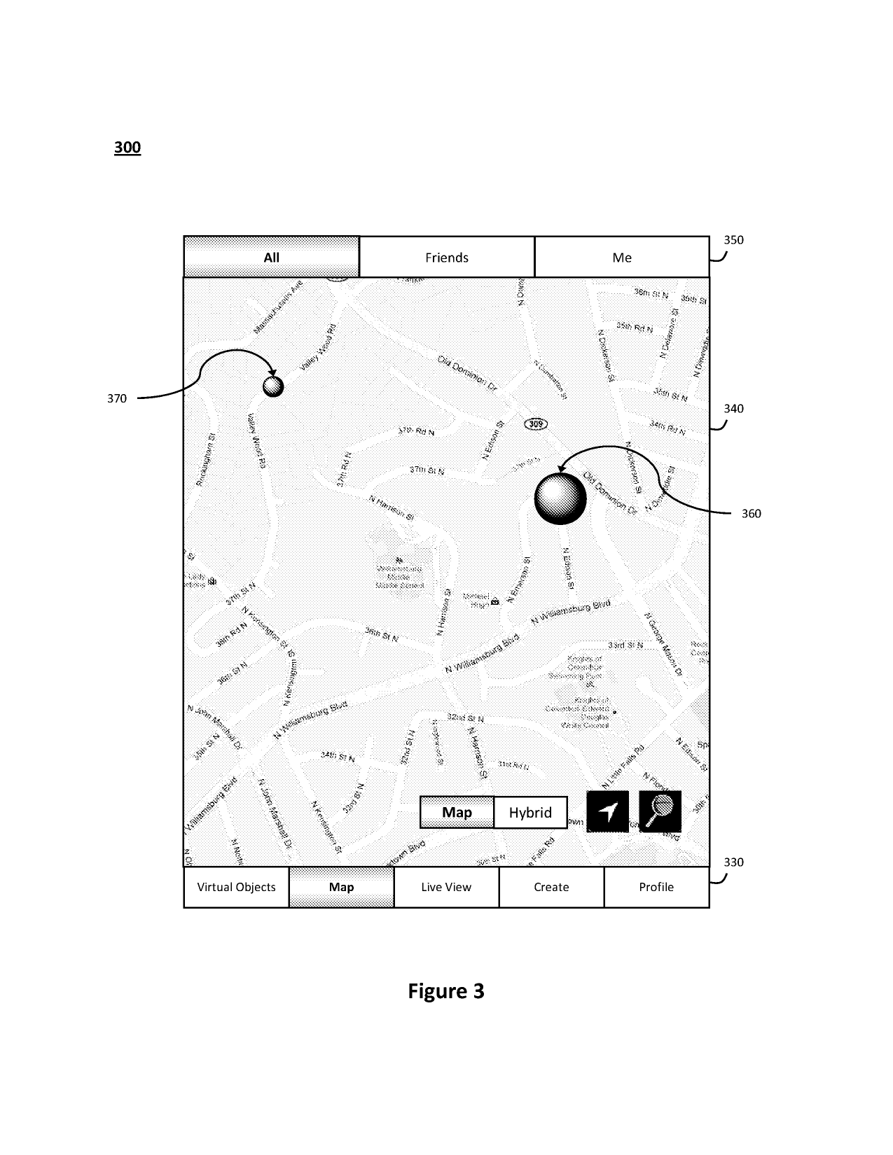

In one implementation, FIG. 3 illustrates an exemplary user interface 300 that may be shown on the mobile device in response to the user selecting the map option in the main menu 330. More particularly, in response to the user selecting the map option in the main menu 330, one or more location sensors on the mobile device (e.g., a GPS sensor, compass, accelerometer, gyroscope, etc.) may determine a current location associated with the mobile device, and the augmented reality application may then communicate location data that represents the current location associated with the mobile device to the augmented reality server. Alternatively, in one implementation, the location data communicated to the augmented reality server may include a default location associated with the mobile device (e.g., a home address associated with the user), whereby the current location referred to herein may correspond to the default location in certain instances, whether or not explicitly stated as such. In one implementation, the augmented reality server may then query one or more suitable databases or repositories to determine locations associated with virtual objects 360 that the user and any other users created with the augmented reality application, wherein the augmented reality server may deliver data to the augmented reality application that relates to any virtual objects 360 located in a certain proximity or suitably near to the current location associated with the mobile device. As such, in one implementation, the augmented reality application may then render or otherwise display a map in the augmented reality area 340, wherein the map may include a layout to represent various roads, points of interest, and other features associated with a physical area encompassing the current location associated with the mobile device, an icon or other indicator 370 to visually represent the current location associated with the mobile device, and any virtual objects 360 located in the physical area shown in the map. Further, in one implementation, the augmented reality area 340 may include an option to display a hybrid version associated with the map, wherein the hybrid version may include a satellite image or view that corresponds to the physical area encompassing the current location associated with the mobile device with road names and other descriptive information superimposed or otherwise overlaid over the satellite image or view.

In one implementation, augmented reality area 340 may further include a compass icon to show the current direction or orientation associated with the mobile device relative to planetary magnetic poles (i.e., to true north) and a zoom option to increase or decrease the physical area shown in the map. In one implementation, the user interface 300 associated with the map option may include a clustering capability to represent multiple virtual objects 360 having respective locations within a suitable proximity to one another. For example, in response to the user selecting the zoom option to increase the physical area shown in the map or otherwise zoom out to a higher geographic level in which multiple virtual objects 360 are located within a certain physical proximity, the multiple virtual objects 360 may be formed into clusters 360, which may represent the multiple virtual objects 360 located within a proximity to locations associated with the clusters 360. Furthermore, in one implementation, the clusters 360 may have different icons than the virtual objects 360 represented therewith (e.g., the virtual objects 360 themselves may have icons corresponding to designs or other customizations that have been applied thereto, whereas the clusters 360 may have specific icons to indicate that multiple virtual objects 360 are represented thereby in addition to information indicating how many virtual objects 360 are contained therein). In addition, the augmented reality area 340 may change, combine, merge, or separate the clusters 360 or the multiple virtual objects 360 represented therewith depending on how much the user has zoomed in or zoomed out the physical area shown in the map, and the user may touch any particular cluster 360 shown in the map to see a list that identifies the multiple virtual objects 360 contained in the cluster 360 and then select a particular one of the multiple virtual objects 360 to further interact with (if so desired). For example, in one implementation, the mobile device may include a touch-screen display that shows the user interface 300, the augmented reality area 340 displayed therein, and all other user interfaces described herein, whereby the user may simply touch the cluster 360 on the map to see and further interact with the multiple virtual objects 360 contained therein.

Accordingly, the map option in the main menu 330 may generally cause the augmented reality area 340 to combine one or more images that represent a certain physical area with data that represents virtual objects 360 located in that physical area, thereby representing an augmented reality that superimposes or otherwise overlays the data that represents virtual objects 360 over the images that represent physical reality, which may enable the user to see where any virtual objects 360 that may be present or otherwise near to the current location associated with the mobile device are located. Additionally, in one implementation, the user interface 300 may include a user menu 350 to configure which virtual objects 360 to display in the augmented reality area 340. For example, in one implementation, the user menu 350 may include an option to display all virtual objects 360 located within the physical reality currently shown in the augmented reality area 340, or alternatively to restrict the displayed virtual objects 360 located therein to those that the user created or to those that friends, contacts, or other users (besides the current user) created. Furthermore, the various roads, points of interest, satellite images (in the hybrid mode), and other visual features associated with the physical reality shown in the augmented reality area 340 in combination with the compass, the zoom option, and the indicator 370 that visually represents the current location associated with the mobile device in the augmented reality area 340 may enable the user to navigate to the locations associated with virtual objects 360 and thereby collect or otherwise interact with the virtual objects 360. More particularly, in response to the location sensors tracking movements or other changes in the current location associated with the mobile device, the indicator 370 in the augmented reality area 340 may be dynamically updated to reflect the current location associated with the mobile device in a substantially continuous manner, and the user may reference the compass, change the zoom level, toggle between the map mode and the hybrid mode, or otherwise interact with the information displayed in the augmented reality area 340 in order to track down and collect virtual objects 360, properly orient and re-orient the virtual objects 360 with respect to distances, positions, and rotations associated therewith and/or other virtual objects 360 relative to the augmented reality area 340, or otherwise manage the virtual objects 360 displayed in the augmented reality area 340.

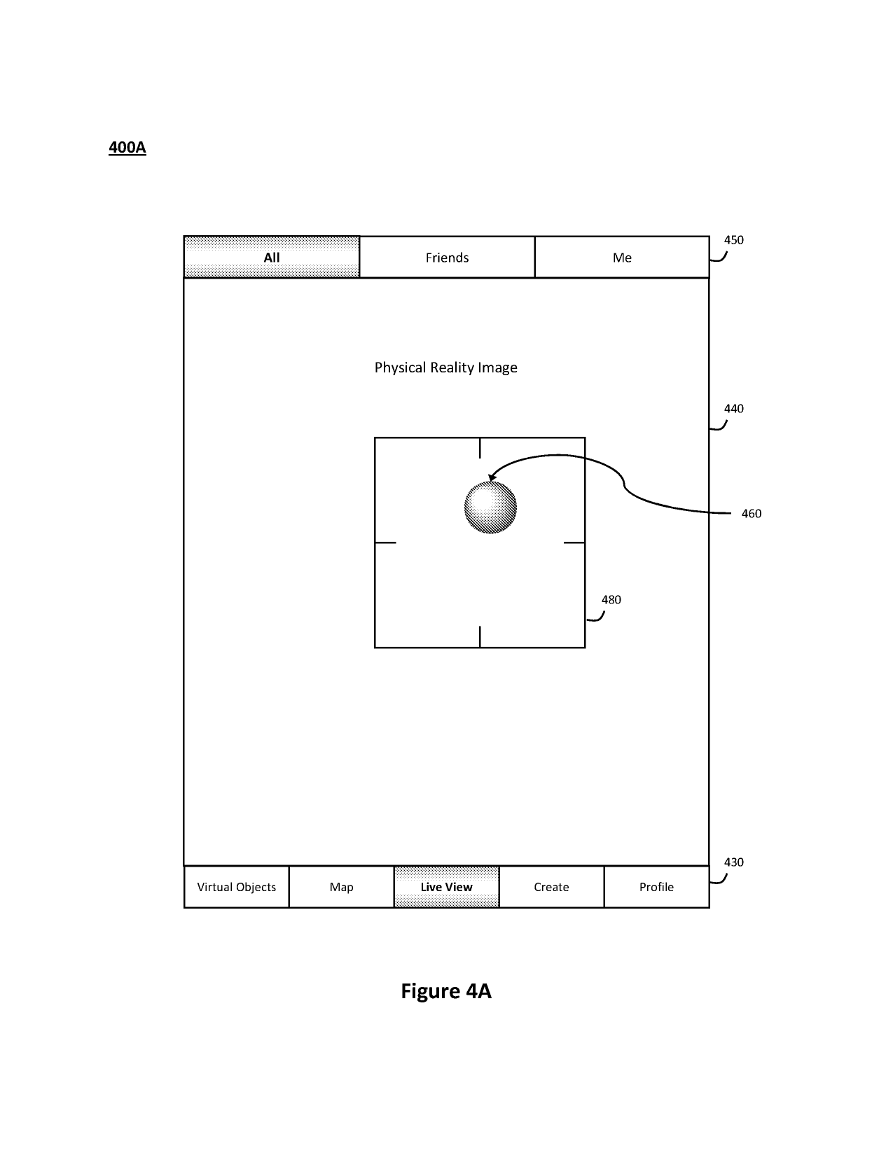

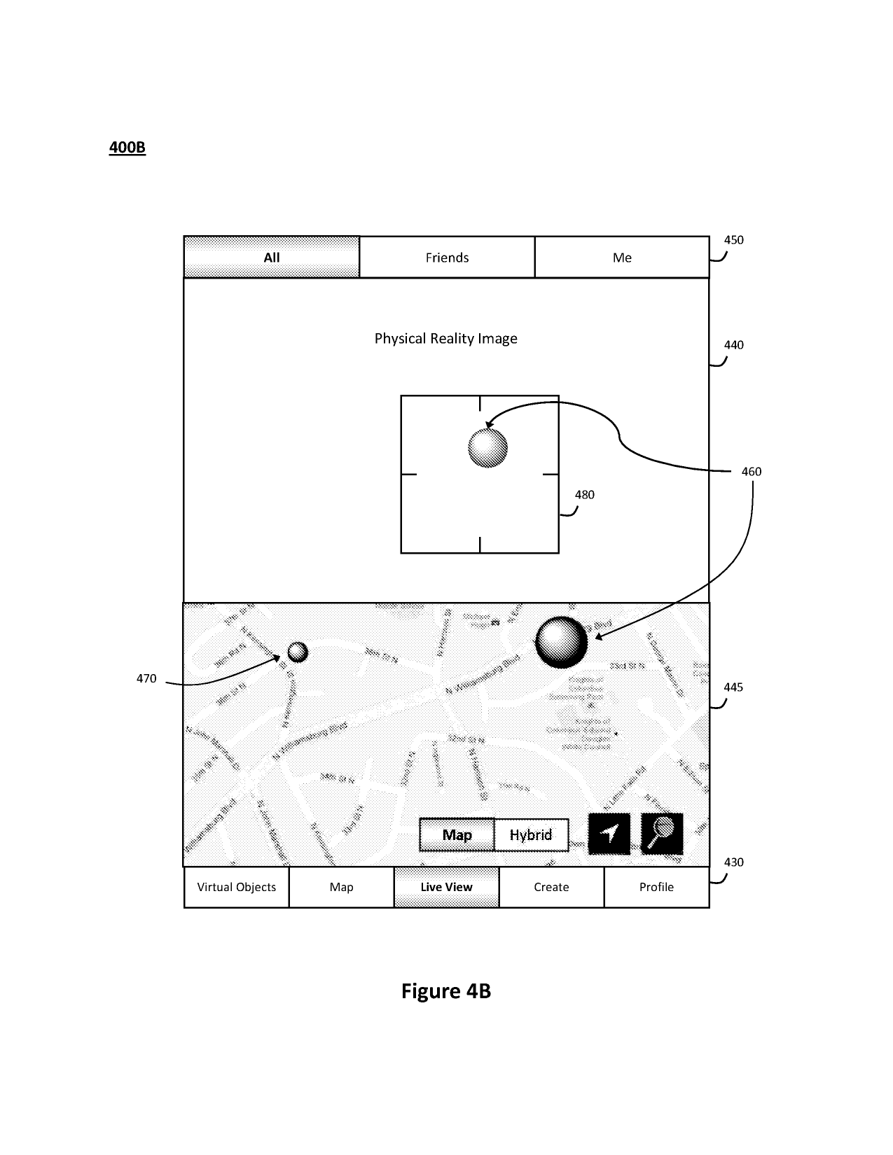

In one implementation, FIG. 4A illustrates an exemplary user interface 400A that may be shown on the mobile device in response to the user selecting the live view option in the main menu 430. More particularly, in response to the user selecting the live view option in the main menu 430, the augmented reality application may obtain a physical reality image representing a current viewpoint associated with a camera on the mobile device, which may then be displayed in the augmented reality area 440. In addition, and substantially simultaneously therewith, the location sensors associated with the mobile device may determine information relating to the current location, position, and/or orientation associated with the mobile device, which the augmented reality application may communicate to the augmented reality server. As such, in one implementation, the augmented reality server may use the current location, position, and/or orientation associated with the mobile device to map location data that represents the current viewpoint associated with the camera on the mobile device (i.e., to determine geographic coordinates or other suitable data that represents the real-world physical reality visible in the current camera viewpoint). In one implementation, the augmented reality server may then query the databases or other repositories to identify any virtual objects 460 having locations that correlate with the current camera viewpoint and deliver data to the augmented reality application that relates to any identified virtual objects 460 having locations that can be suitably projected from the current camera viewpoint. For example, in one implementation, the augmented reality server may determine a forward projection associated with a plane that represents the current camera viewpoint, wherein the identified virtual objects 460 may have locations that fall within the projected plane (e.g., even if the virtual objects 460 are located behind trees, buildings, or other structures in the real-world physical reality). In one implementation, the augmented reality application may then refresh the augmented reality area 440 to superimpose or otherwise overlay any virtual objects 460 that the augmented reality server identified over the physical reality image that represents the current camera viewpoint, and may further display one or more visual features 480 to assist the user in locating the virtual objects 460. For example, the visual features 480 may include crosshairs, a telescopic sight, a precision pointer, a focus area, or any other suitable visual features that may assist the user interpreting where the virtual objects 460 may be located in physical reality based on the image representing the current camera viewpoint.

Accordingly, the live view option in the main menu 430 may generally cause the augmented reality area 440 to combine a physical reality image that represents a current viewpoint associated with the camera and data that represents virtual objects 460 located in the forward projected plane, thereby creating an augmented reality that may enable the user to locate, collect, and otherwise interact with any virtual objects 460 that may be located therein. Furthermore, the manner in which the augmented reality area 440 shows the virtual objects 460 against the physical reality image may be dynamically updated in response to the location sensors tracking movements or other changes in the current location, position, and/or orientation associated with the mobile device, which may reflect changes in the current viewpoint associated with the camera. For example, in one implementation, based on the changes in the current location, position, and/or orientation associated with the mobile device, the augmented reality application may use the location data associated with the virtual objects 460 to suitably update the current location, position, and/or orientation that the virtual objects 460 have within the current camera viewpoint (e.g., showing visual design features associated with the virtual objects 460 based on the camera viewpoint relative to the location associated with the virtual objects 460, making the virtual objects larger or smaller within the augmented reality area 440 depending on whether the camera viewpoint has moved closer or farther away from the location associated with the virtual objects, etc.). In one implementation, in response to the augmented reality application determining that the virtual objects 460 are within a suitable proximity to the current camera viewpoint (e.g., substantially close enough that the user could touch a particular virtual object 460 if the virtual object 460 was physically present), the augmented reality application may then enable the user to collect, view, move, and/or otherwise interact with virtual objects 460.

Furthermore, in one implementation, FIG. 4B illustrates an exemplary alternative user interface 400B that may be shown on the mobile device in response to the user selecting the live view option in the main menu 430. More particularly, in addition to displaying the augmented reality area 440 that shows the physical reality image to represent the current camera viewpoint, the virtual objects 460 having locations that correlate therewith, and the various visual features 480 to assist the user in locating and interpreting the virtual objects 460 located therein, the user interface 400B shown in FIG. 4B may simultaneously display a map view 445 corresponding to the current location associated with the mobile device. In one implementation, the map view 445 may generally be managed and have characteristics substantially similar to the user interface illustrated in FIG. 3 and described in further detail above. For example, in one implementation, the map view may show various roads, points of interest, and other features associated with a physical area encompassing the current location associated with the mobile device, an icon or other indicator 470 to visually represent the current location associated with the mobile device, and the virtual objects 460 located in the physical area shown in the map. Furthermore, in one implementation, the map view 445 shown in FIG. 4B may include similar options to display a hybrid version associated with the map (e.g., a satellite image that corresponds to the physical area shown therein, with road names and other descriptive information superimposed or otherwise overlaid), a compass icon to show the current direction or orientation associated with the mobile device, and a zoom option to increase or decrease the physical area represented in the map view 445. Accordingly, in one implementation, the user interface 400B shown in FIG. 4B may combine the augmented reality area 440 and the map view 445, which may respectively have substantially similar characteristics to the user interfaces shown in FIG. 4A and FIG. 3, which may enable the user to simultaneously employ the features associated with either or both user interfaces to interact with the virtual objects 460 in augmented realities.

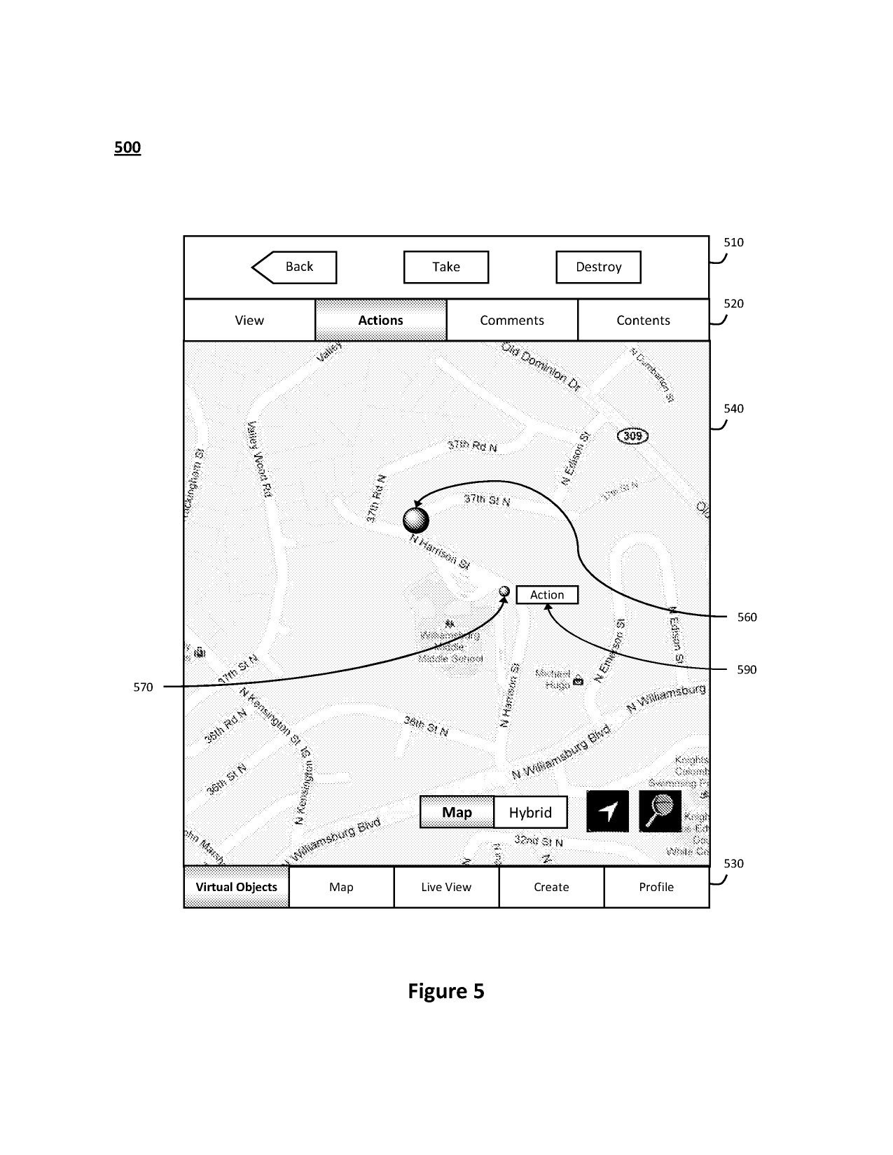

In one implementation, FIG. 5 illustrates an exemplary user interface 500 that may be shown on the mobile device in response to the mobile device having a suitable proximity to a particular virtual object 560 and the user selecting the actions option in the virtual object menu 520 to collect, view, move, and/or otherwise interact with the virtual object 560. More particularly, in response to the user selecting the actions option in the virtual object menu 520, the augmented reality application may refresh the augmented area 540 to display a map having substantially similar features to the user interface 300 shown in FIG. 3 and described in further detail above (e.g., providing options to toggle between a map mode that shows roads, points of interest, and other physical map features and a hybrid mode that superimposes the physical map features over a satellite image or view, providing compass and zoom options to assist the user interpreting the physical surroundings shown in the augmented reality area 540, providing a visual indicator 570 to represent the current location associated with the mobile device, showing the location associated with the virtual object 560 on the map, etc.). In one implementation, the zoom option may enable the user to increase or decrease the physical surroundings shown in the augmented reality area 540 and thereby provide additional control over the particular physical location to move the virtual object 560 (e.g., the user may zoom out to show a map corresponding to a large physical area and then use the action option 590 to move the virtual object 560 anywhere in the physical area shown therein).

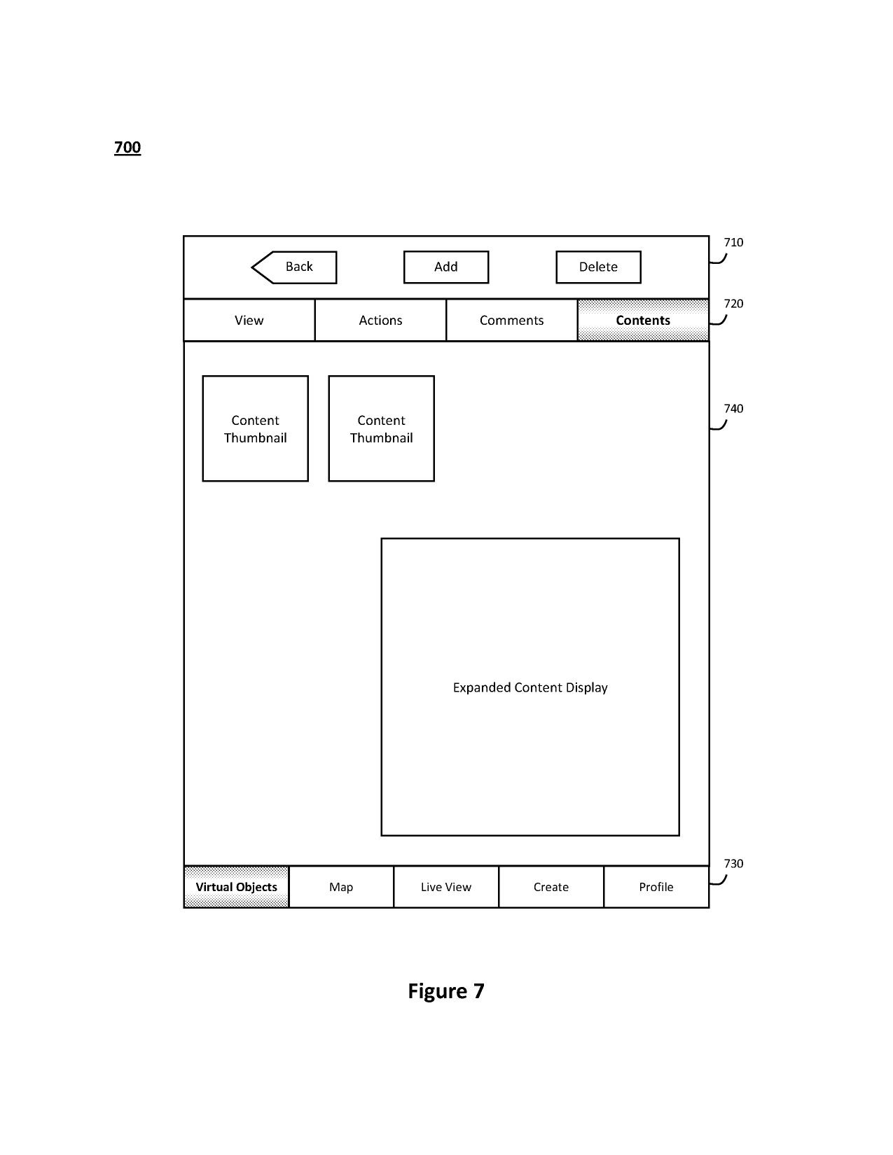

Additionally, in one implementation, the user interface 500 may include the interaction menu 510 to enable the user to take, collect, destroy, kick, move, and/or otherwise interact with the virtual object 560, and the augmented reality area 540 may further include an action option 590 to invoke the appropriate action on the virtual object 560. For example, as noted above, the touch-screen display associated with the mobile device may show the user interface 500, the augmented reality area 540 displayed therein, and all other user interfaces described herein, whereby the user may simply touch any suitable virtual object 560 on the touch-screen display to open the virtual object 560, see content or other virtual items that may be embedded therein, and interact with the embedded content or other virtual items embedded therein if so desired (e.g., as described in further detail below with respect to FIG. 7). Accordingly, the action option 590 may enable the user to specify a certain location on the map shown in the augmented reality area 540 and kick or otherwise move the virtual object 560 to the specified location. Furthermore, in one implementation, the augmented reality server may use the low-latency communication technology described above to adjudicate situations in which multiple users invoke the action option 590 to trigger different actions on a particular virtual object 560 at substantially the same time. For example, if the different actions are incompatible (e.g. because the multiple users moved the virtual object 560 in opposite directions) the augmented reality server may execute the action that happened first in time, discard any subsequent actions incompatible therewith, and then notify the augmented reality applications on the mobile devices associated with any other users that triggered the subsequent incompatible actions. More particularly, in response to the augmented reality server notifying the augmented reality applications associated with the other users that the first action was executed and the subsequent incompatible actions were discarded, the augmented reality applications may then update or otherwise correct the information displayed in the augmented reality area 540 to properly reflect the first action that was executed in lieu of the subsequent incompatible actions that were discarded (e.g., if the augmented reality area 540 was updated to indicate that the subsequent action occurred, the augmented reality area 540 may be updated or otherwise corrected to undo the subsequent action even if the augmented reality area 540 previously showed that the action was triggered). As such, in one implementation, the low-latency communication technology may result in the augmented reality server delivering an event relating to the action that happened first in time to the augmented reality application, which may cause the augmented reality application to update or otherwise correct the augmented reality area 540 in approximately half a second (e.g., to reflect that the subsequent incompatible action was not triggered on the virtual object 560 and that the first action initiated by the other user was triggered).

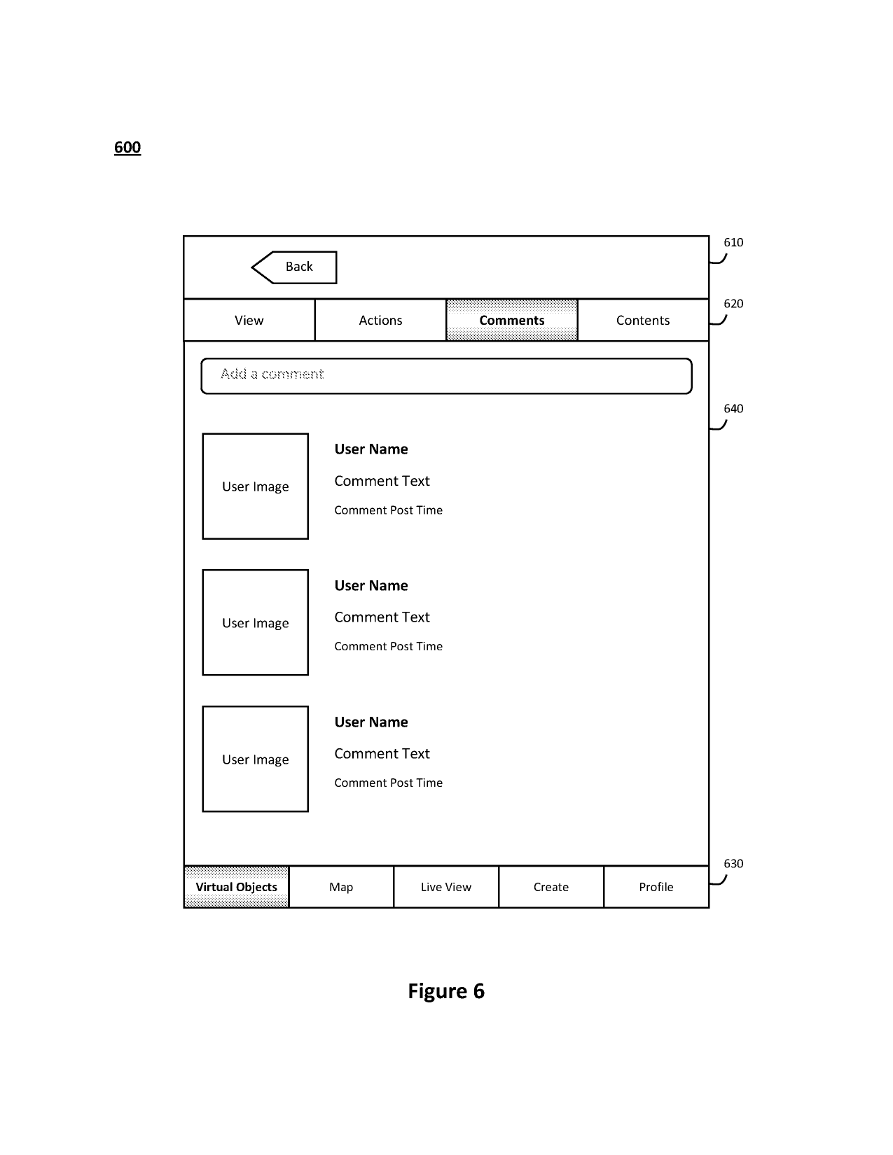

Furthermore, in one implementation, FIG. 6 illustrates an exemplary user interface 600 that may be shown on the mobile device in response to using the augmented reality application to collect or otherwise interact with a virtual object having a suitable proximity to the mobile device and the user selecting the comments option in the virtual object menu 620. More particularly, in response to the user selecting the comments option in the virtual object menu 620, the augmented reality application may cause the user interface 600 to show a comments display 640, which may include one or more comment entries that relate to postings submitted by various users that may have created, collected, or otherwise interacted with the virtual object. For example, in one implementation, the comment entries may generally include an icon, thumbnail, picture, or other suitable image associated with the users that submitted the postings relating to the virtual object, a name or other suitable identifier associated with the users, text that the users submitted to post the comments relating to the virtual object, and timestamps that represent when the users submitted the comments relating to the virtual object. Moreover, in one implementation, the comments display 640 may include a comment box or other suitable user interface feature where the user can post text, links, or other data to comment on the virtual object. Accordingly, in response to the user posting text, links, or other data to comment on the virtual object, the comment entries in the comments display 640 may be refreshed include the text, links, or other data that the user posted in addition to an image, name, and timestamp associated with the user comment. As such, the comment display 640 may enable social networking among the various users that created, collected, or otherwise interacted with the virtual object (e.g., to enable the user to stay in touch with friends, meet new people, or otherwise engage in social interactions via the virtual object).

Additionally, in one implementation, FIG. 7 illustrates an exemplary user interface 700 that may be shown on the mobile device in response to the user collecting or otherwise interacting with the virtual object and selecting the contents option in the virtual object menu 720. More particularly, in response to the user selecting the contents option in the virtual object menu 720, the augmented reality application may cause the user interface 700 to show a contents display 740, which may include one or more thumbnails to represent text, pictures, graphics, audio, video, icons, games, software, or other content or virtual items that one or more other users embedded in the virtual object. As such, in one implementation, the user may select the content thumbnails to view, collect, download, or otherwise interact with the content or other virtual items embedded in the virtual object, and moreover, the interaction menu 710 may include one or more options to add content or other virtual items to embed within the virtual object, delete content or other virtual items embedded in the virtual object, or otherwise manage the content or other virtual items embedded therein. Accordingly, the user interface 700 shown in FIG. 7 may generally enable users to share content or other virtual items, participate in treasure or scavenger hunts to locate and/or collect content or other virtual items embedded in virtual objects, obtain special offers, coupons, deals, or other incentives embedded in virtual objects, play geocaching or other interactive games that relate to collecting virtual objects and content or other virtual items embedded therein, or otherwise use the augmented reality application to distribute content or other virtual items to any suitable worldwide location via the virtual objects.

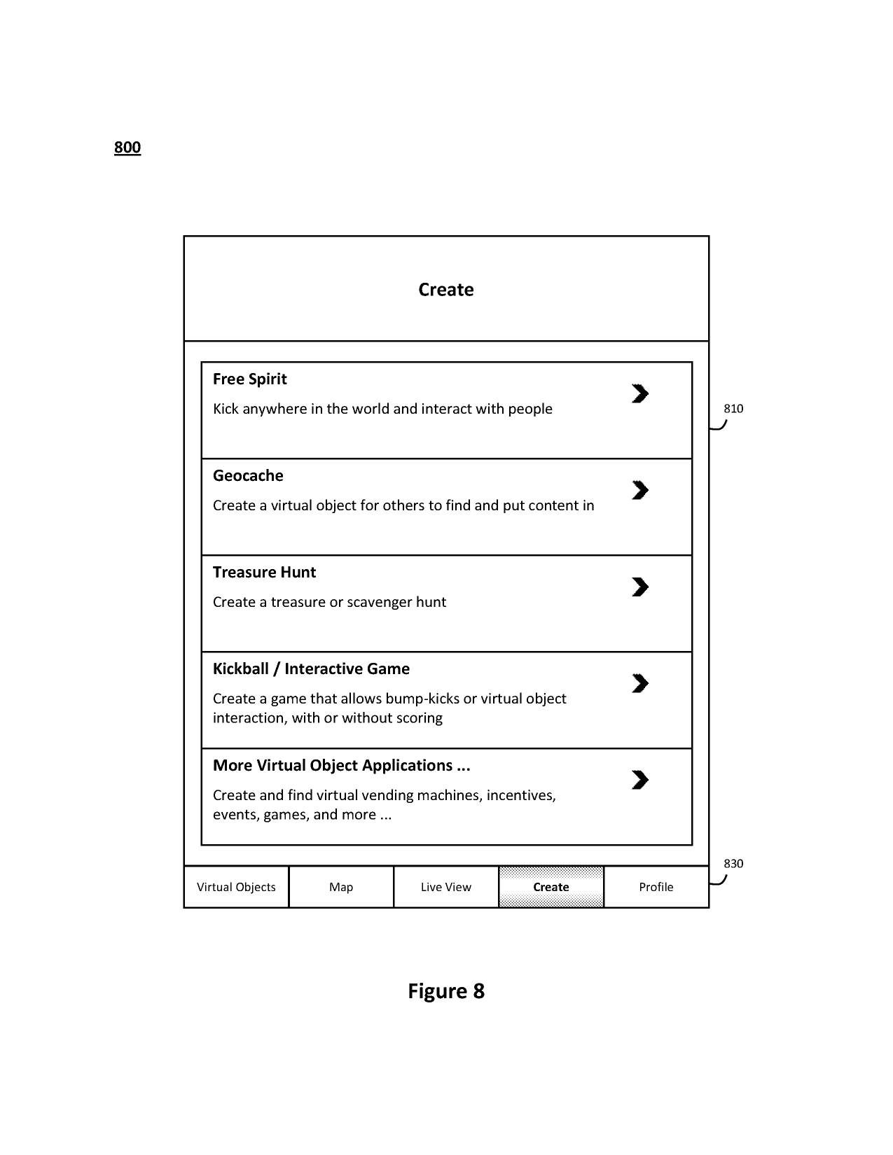

For example, in one implementation, FIG. 8 illustrates an exemplary user interface 800 that may be used to create virtual objects that can be interacted with in augmented realities in various ways, wherein the user interface 800 shown in FIG. 8 may be displayed on the mobile device in response to the user selecting the create option in the main menu 830. More particularly, in response to the user selecting the create option in the main menu 830, the augmented reality application may display a create menu 810 that provides various options to create virtual objects and define how users may appropriately interact therewith. For example, in one implementation, the create menu 810 may include a “Free Spirit” option to create a virtual object that can be deployed to any suitable worldwide location and interacted with by other users, whereby other users that discover the virtual object may then kick or otherwise move the virtual object to a new worldwide location in response to finding the virtual object in the original location. In addition, the create menu 810 may include a “Geocache” option to create a virtual object having content or other virtual items embedded therein, which can then be deployed to any suitable worldwide location to enable other users to locate the virtual object, embed additional content or other virtual items, and otherwise interact with the content or other virtual items associated with the virtual object, although the users may be prevented from moving the virtual object to another location to ensure that other users will be able to suitably locate the virtual object associated with the Geocache option. In one implementation, the create menu 810 may further include a “Treasure Hunt” option to deploy virtual objects to various worldwide locations and define clues that users may decipher to locate the virtual objects and thereby participate in a virtual scavenger hunt to locate and/or collect virtual objects or content or other virtual items embedded therein. Furthermore, in one implementation, the Treasure Hunt option may make one or more virtual objects to be located and collected therein initially invisible, whereby the one or more initially invisible virtual objects may only become visible to any particular user participating in the Treasure Hunt in response to the user having suitably located and collected one or more previous virtual objects that are prerequisites to the initially invisible virtual objects. Moreover, as noted above, the augmented reality application may support various other virtual object applications, including virtual vending machines or deal finder applications to locate virtual objects in real-world locations that have special offers, coupons, deals, or other incentives associated therewith and various other applications described or otherwise mentioned above, and as will be described in further detail below, the create menu 810 may further include an interactive game option that allows users to play kickball or other games to interact with the virtual objects in a manner that involves bump-kicks or other interactions via the augmented reality application.

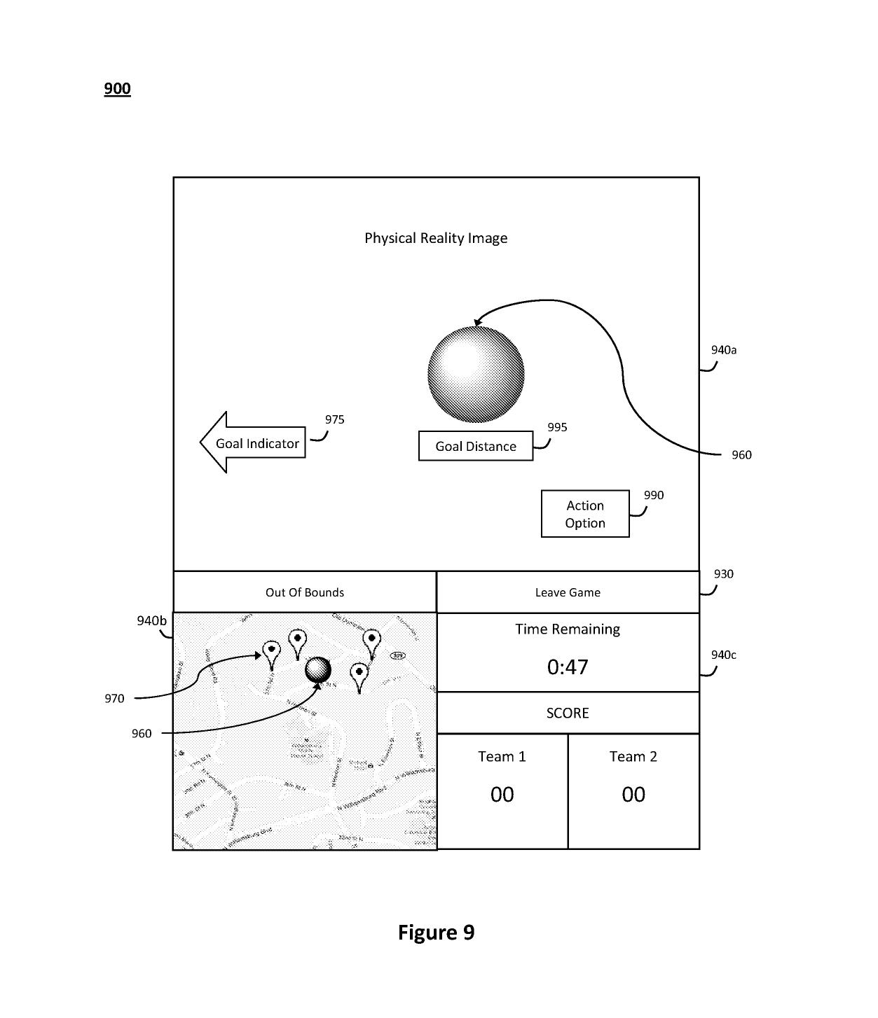

For example, in one implementation, FIG. 9 illustrates an exemplary user interface 900 that may be shown on the mobile device to enable users to play kickball or another interactive game that involve bump-kicks, nudges, or other suitable actions to interact with a virtual ball 960 via the augmented reality application. In particular, like the user interface shown in FIG. 4B and described in further detail above, the user interface 900 shown in FIG. 9 may simultaneously display an augmented reality (or live view) area 940a that shows a physical reality image that corresponds to a current viewpoint associated with a camera on the mobile device and a map view 940b that shows a layout associated with roads and other features in a physical area encompassing a current location associated with the mobile device, wherein the live view 940a and the map view 940b may generally represent a virtual field where one or more users (or players) interact with the virtual object 960 and attempt to invoke bump-kicks, nudges, or other actions to move the virtual ball 960 into a virtual goal. Furthermore, in one implementation, the user interface 900 may include a game menu 930 that provides various options to manage the interactive game and a virtual scoreboard 940c that displays status information associated with the interactive game.

In one implementation, the live view 940a may generally superimpose the virtual ball 960 and/or the virtual goal over the physical reality image corresponding to the current camera viewpoint if current locations associated with the virtual ball 960 and/or the virtual goal fall within the current camera viewpoint. Alternatively, if the current locations associated with the virtual ball 960 and/or the virtual goal fall outside the current camera viewpoint, the live view 940a may include a direction indicator 975 and a distance indicator 995 to respectively show where and how far away the virtual ball 960 and/or the virtual goal are located relative to the current camera viewpoint. For example, in one implementation, FIG. 9 shows a particular scenario in which the current location associated with the virtual ball 960 falls within the current camera viewpoint and the current location associated with the virtual goal falls outside the current camera viewpoint, whereby the live view 940a superimposes the virtual ball 960 over the physical reality image and provides the direction indicator 975 to show the location associated with the virtual goal relative to the current camera viewpoint (i.e., to the left) and the distance indicator 995 to show the distance between the virtual goal and the current camera viewpoint (e.g., how far away in terms of feet, miles, or other distances). Furthermore, in one implementation, the map view 940b may superimpose the virtual ball 960 over the road layout that represents the physical area encompassing the current location associated with the mobile device and further superimpose various map pins 970 over the road layout to show the virtual goals into which the virtual ball 960 must be moved to score goals or other points.

In one implementation, to play the interactive game, the live view 940a may include an action option 990 that may be invoked to trigger a bump-kick, nudge, or other action on the virtual ball 960, or the live view 940a may alternatively omit the action option 990 to enable a user (or player) to trigger the action on the virtual ball 960 simply via moving the mobile device. For example, in the latter case, the action may be invoked in response to the player approaching the virtual ball 960 and coming within a certain proximity thereto, at which time the virtual ball 960 may automatically move to a new location based on a current direction, elevation angle, or other orientation associated with the mobile device. Furthermore, in one implementation, the distance that the virtual ball 960 moves may depend on a speed at which the player moved the mobile device over the ground at the time that the mobile device came close enough to the virtual ball 960 to trigger the action. Alternatively, in the former case where the live view 940a includes the action option 990, the player may select the action option 990 to trigger the bump-kick, nudge, or other action on the virtual ball 960 once the mobile device has been moved within the proximity to the virtual ball 960 required to trigger the action. For example, in one implementation, the action option 990 may be disabled or only appear once the mobile device has been moved within the required proximity, at which time the action option 990 may be selected and subsequent gestures that involve moving the mobile device may trigger the action. As such, the action option 990 may be used to move the virtual ball 960 in a generally similar manner to the automatic mechanism described above via the subsequent gestures (e.g., moving the location associated the virtual ball 960 a certain distance based on the direction, elevation angle, orientation, and speed at which the gestures occurred).

Accordingly, in one implementation, the user interface 900 shown in FIG. 9 may generally support multiple users playing kickball or other interactive games in substantially real-time (e.g., via the low-latency communication technology to synchronize actions that the multiple players may trigger on the virtual ball 960 among multiple augmented reality applications in very little time). In one implementation, the players playing the interactive game may generally be arranged in opposing teams, whereby the players may move the virtual ball 960 around the virtual field via appropriate gestures and movements associated with the mobile device and awarded goals or other suitable points in response to moving the virtual ball 960 into the virtual goal associated with the opposing team. As such, in one implementation, the virtual scoreboard 940c may display in substantially real-time status information associated with the interactive game, including how much time remains in the game and the current score (e.g., in FIG. 9, the virtual scoreboard 940c shows that forty-seven minutes remain in the game and that both teams have yet to score any goals or points). In addition, the various options to manage the interactive game via the game menu 930 may enable the participating players to define boundaries associated with the virtual field (i.e., an area in the physical reality that the virtual ball 960 must remain within to avoid going out of bounds) and may further enable the participating players to leave the game at any time. Furthermore, in one implementation, the game menu 930 may provide other options to manage the game that are not specifically shown in FIG. 9. For example, in one implementation, the game menu 930 may provide options to define settings whereby the interactive game can be played with all the players in the same physical space or different physical spaces. For example, if the players are located in different physical spaces, the augmented reality server may temporarily overlay or otherwise merge the different physical spaces in which the players are located into one virtual field. As such, the overlay or merge option may allow players on different teams to be located in different physical spaces but play against one another on the same virtual field.

Implementations of the invention may be made in hardware, firmware, software, or any suitable combination thereof. The invention may also be implemented as instructions stored on a machine-readable medium that can be read and executed on one or more processing devices. For example, the machine-readable medium may include various mechanisms that can store and transmit information that can be read on the processing devices or other machines (e.g., read only memory, random access memory, magnetic disk storage media, optical storage media, flash memory devices, or any other storage or non-transitory media that can suitably store and transmit machine-readable information). Furthermore, although firmware, software, routines, or instructions may be described in the above disclosure with respect to certain exemplary aspects and implementations performing certain actions or operations, it will be apparent that such descriptions are merely for the sake of convenience and that such actions or operations in fact result from processing devices, computing devices, processors, controllers, or other hardware executing the firmware, software, routines, or instructions. Moreover, to the extent that the above disclosure describes executing or performing certain operations or actions in a particular order or sequence, such descriptions are exemplary only and such operations or actions may be performed or executed in any suitable order or sequence.

Furthermore, aspects and implementations may be described in the above disclosure as including particular features, structures, or characteristics, but it will be apparent that every aspect or implementation may or may not necessarily include the particular features, structures, or characteristics. Further, where particular features, structures, or characteristics have been described in connection with a specific aspect or implementation, it will be understood that such features, structures, or characteristics may be included with other aspects or implementations, whether or not explicitly described. Thus, various changes and modifications may be made to the preceding disclosure without departing from the scope or spirit of the invention, and the specification and drawings should therefore be regarded as exemplary only, with the scope of the invention determined solely by the appended claims.

What is claimed is:

1. A mobile device for interacting with virtual objects in augmented realities, comprising:
one or more location sensors configured to determine a location associated with the mobile device; and
a processor configured to:
communicate the location associated with the mobile device to an augmented reality server, wherein the augmented reality server correlates the location associated with the mobile device to one or more virtual objects;
receive, from the augmented reality server, data associated with the one or more virtual objects correlated to the location associated with the mobile device, wherein the data associated with the one or more virtual objects includes locations associated with the one or more virtual objects;
display, on the mobile device, an augmented reality that superimposes the one or more virtual objects over one or more images that represent physical surroundings associated with the mobile device, wherein the one or more virtual objects are superimposed over the one or more images at the locations associated with the one or more virtual objects; and
process one or more requests to interact with the one or more virtual objects in the augmented reality using an augmented reality application.

2. The mobile device of claim 1, wherein the one or more images that represent the physical surroundings associated with the mobile device include a map associated with a physical area that encompasses the location associated with the mobile device.

3. The mobile device of claim 1, wherein the one or more images that represent the physical surroundings associated with the mobile device include a satellite view associated with a physical area that encompasses the location associated with the mobile device.

4. The mobile device of claim 1, further comprising a camera configured to sense the physical surroundings associated with the mobile device, wherein the physical surroundings sensed with the camera represents a current viewpoint associated with the mobile device.

5. The mobile device of claim 4, wherein the processor is further configured to:
obtain a position and an orientation associated with the mobile device using the one or more location sensors; and
communicate the position and the orientation associated with the mobile device to the augmented reality server, wherein the augmented reality server correlates the position and the orientation associated with the mobile device to the location associated with the mobile device to map the current viewpoint associated with the mobile device.

6. The mobile device of claim 4, wherein the one or more images that represent the physical surroundings associated with the mobile device include a map associated with a physical area that encompasses the location associated with the mobile device and the current viewpoint associated with the mobile device.

7. The mobile device of claim 1, wherein the one or more requests cause the augmented reality application to collect the one or more virtual objects, destroy the one or more virtual objects, or move the one or more virtual objects to new locations if the locations associated therewith are substantially near to the location associated with the mobile device.

8. The mobile device of claim 1, wherein the one or more requests cause the augmented reality application to obtain content or virtual items embedded in the one or more virtual objects from the augmented reality server or upload content or virtual items to embed in the one or more virtual objects to the augmented reality server if the locations associated therewith are substantially near to the location associated with the mobile device.

9. The mobile device of claim 8, wherein the content or virtual items obtained from the augmented reality server and the content or virtual items uploaded to the augmented reality server includes text, pictures, graphics, audio, video, icons, games, software, incentive, or advertising content associated with the one or more virtual objects.

10. The mobile device of claim 1, wherein the physical surroundings associated with the mobile device include a virtual field and the one or more virtual objects superimposed over the one or more images in the augmented reality include a three-dimensional virtual ball and a three-dimensional virtual goal, and wherein the one or more requests relate to playing an interactive game in which gestures associated with the mobile device cause the three-dimensional virtual ball to move within the virtual field, goals are scored if the gestures cause the three-dimensional virtual ball to enter the three-dimensional virtual goal, and the displayed augmented reality includes a virtual scoreboard to track information relating to the interactive game.

11. The mobile device of claim 10, wherein the gestures associated with the mobile device cause the three-dimensional virtual ball to move to a new location within the virtual field based on a current direction, elevation angle, and speed associated with the gestures at a time when the location associated with the mobile device and the location associated with the three-dimensional virtual ball are within a predetermined proximity.

12. The mobile device of claim 10, wherein the virtual field comprises a virtual space that overlays a first physical space where one or more players on a first team in the interactive game are located with a second physical space where one or more players on a second team in the interactive game are located.

13. The mobile device of claim 10, wherein the processor is further configured to communicate with the augmented reality server over a persistent connection using low-latency communication technology to synchronize the one or more requests that relate to playing the interactive game in substantially real-time.

14. The mobile device of claim 1, wherein the processor is further configured to manage a treasure or scavenger hunt in which multiple users are given clues to describe the locations associated with the one or more virtual objects in a predetermined sequence and subsequent virtual objects in the predetermined sequence only become visible to the multiple users upon collecting prior prerequisite virtual objects in the predetermined sequence.

15. The mobile device of claim 1, wherein the processor is further configured to communicate with the augmented reality server over a persistent connection using low-latency communication technology to synchronize the one or more requests to interact with the one or more virtual objects with one or more other requests that one or more other mobile devices initiate to interact with the one or more virtual objects in substantially real-time.

16. The mobile device of claim 15, wherein the processor is further configured to:
receive one or more events from the augmented reality server that relate to the one or more other requests that the one or more other mobile devices initiated to interact with the one or more virtual objects over the persistent connection, wherein the one or more events indicate that the one or more other requests were initiated earlier in time than the one or more requests processed to interact with the one or more virtual objects; and
update the augmented reality displayed on the mobile device to reflect the one or more other requests that were initiated prior in time in lieu of the one or more requests processed to interact with the one or more virtual objects.

17. The mobile device of claim 1, wherein the processor is further configured to:
zoom out on the one or more images that represent the physical surroundings associated with the mobile device to represent a larger geographic area;
receive, from the augmented reality server, data associated with multiple virtual objects having locations in the larger geographic area represented in the one or more images; and
form one or more clusters to contain the multiple virtual objects in response to the locations associated therewith having a predetermined proximity to one another, wherein the one or more clusters indicate a number of the multiple virtual objects contained therein.

18. The mobile device of claim 17, wherein the processor is further configured to display, on the mobile device, a list that identifies the multiple virtual objects in the one or more clusters in response to a selection associated with the one or more clusters, wherein the one or more requests relate to one of the multiple virtual objects selected from the displayed list.

19. The mobile device of claim 1, wherein the one or more requests cause the augmented reality application to post comments relating to the one or more virtual objects on the augmented reality server.

20. The mobile device of claim 1, wherein the one or more virtual objects superimposed over the one or more images in the augmented reality have three-dimensional shapes and custom designs, images, or photographs wrapped around surfaces associated therewith, and wherein movements associated with the mobile device cause the displayed augmented reality to show the one or more virtual objects from different perspectives.

21. The mobile device of claim 1, wherein the mobile device comprises a smartphone, augmented reality glasses, augmented reality contact lenses, a head-mounted display, or augmented reality technology directly tied to a human brain.

22. The mobile device of claim 1, wherein the processor is further configured to communicate criteria to restrict or control access to the one or more virtual objects to the augmented reality server.

23. A method for interacting with virtual objects in augmented realities, comprising:
determining a location associated with a mobile device via one or more location sensors on the mobile device;
communicating, by a processor on the mobile device, the location associated with the mobile device to an augmented reality server that correlates the location associated with the mobile device to one or more virtual objects;
receiving, at the mobile device, data from the augmented reality server that relates to the one or more virtual objects correlated to the location associated with the mobile device, wherein the data that relates to the one or more virtual objects includes locations associated with the one or more virtual objects;
displaying, on the mobile device, an augmented reality that superimposes the one or more virtual objects over one or more images that represent physical surroundings associated with the mobile device, wherein the one or more virtual objects are superimposed over the one or more images at the locations associated with the one or more virtual objects; and
processing one or more requests to interact with the one or more virtual objects in the augmented reality using an augmented reality application executing on the mobile device.

24. The method of claim 23, wherein the one or more images that represent the physical surroundings associated with the mobile device include a map associated with a physical area that encompasses the location associated with the mobile device.

25. The method of claim 23, wherein the one or more images that represent the physical surroundings associated with the mobile device include a satellite view associated with a physical area that encompasses the location associated with the mobile device.

26. The method of claim 23, further comprising sensing the physical surroundings associated with the mobile device using a camera on the mobile device, wherein the sensed physical surroundings represents a current viewpoint associated with the mobile device.

27. The method of claim 26, further comprising:
obtaining a position and an orientation associated with the mobile device using the one or more location sensors; and
communicating, by the processor, the position and the orientation associated with the mobile device to the augmented reality server, wherein the augmented reality server correlates the position and the orientation associated with the mobile device to the location associated with the mobile device to map the current viewpoint associated with the mobile device.

28. The method of claim 26, wherein the one or more images that represent the physical surroundings associated with the mobile device include a map associated with a physical area that encompasses the location associated with the mobile device and the current viewpoint associated with the mobile device.

29. The method of claim 23, wherein processing the one or more requests includes using the augmented reality application to collect the one or more virtual objects, destroy the one or more virtual objects, or move the one or more virtual objects to new locations if the locations associated therewith are substantially near to the location associated with the mobile device.

30. The method of claim 23, wherein processing the one or more requests includes using the augmented reality application to obtain content or virtual items embedded in the one or more virtual objects from the augmented reality server or upload content or virtual items to embed in the one or more virtual objects to the augmented reality server if the locations associated therewith are substantially near to the location associated with the mobile device.

31. The method of claim 30, wherein the content or virtual items obtained from the augmented reality server and the content or virtual items uploaded to the augmented reality server includes text, pictures, graphics, audio, video, icons, games, software, incentive, or advertising content associated with the one or more virtual objects.

32. The method of claim 23, wherein the physical surroundings associated with the mobile device include a virtual field and the one or more virtual objects superimposed over the one or more images in the augmented reality include a three-dimensional virtual ball and a three-dimensional virtual goal, and wherein processing the one or more requests includes using the augmented reality application to play an interactive game in which gestures associated with the mobile device cause the three-dimensional virtual ball to move within the virtual field, goals are scored if the gestures cause the three-dimensional virtual ball to enter the virtual goal, and the displayed augmented reality includes a virtual scoreboard to track information relating to the interactive game.

33. The method of claim 32, wherein the gestures associated with the mobile device cause the three-dimensional virtual ball to move to a new location within the virtual field based on a current direction, elevation angle, and speed associated with the gestures at a time when the location associated with the mobile device and the location associated with the three-dimensional virtual ball are within a predetermined proximity.

34. The method of claim 32, wherein the virtual field comprises a virtual space that overlays a first physical space where one or more players on a first team in the interactive game are located with a second physical space where one or more players on a second team in the interactive game are located.

35. The method of claim 32, further comprising communicating with the augmented reality server over a persistent connection using low-latency communication technology to synchronize the one or more requests that relate to playing the interactive game in substantially real-time.

36. The method of claim 23, further comprising managing, via the augmented reality application, a treasure or scavenger hunt in which multiple users are given clues to describe the locations associated with the one or more virtual objects in a predetermined sequence and subsequent virtual objects in the predetermined sequence only become visible to the multiple users upon collecting prior prerequisite virtual objects in the predetermined sequence.

37. The method of claim 23, further comprising communicating with the augmented reality server over a persistent connection using low-latency communication technology to synchronize the one or more requests to interact with the one or more virtual objects with one or more other requests that one or more other mobile devices initiate to interact with the one or more virtual objects in substantially real-time.

38. The method of claim 37, further comprising:
receiving, at the augmented reality application executing on the mobile device, one or more events from the augmented reality server that relate to the one or more other requests that the one or more other mobile devices initiated to interact with the one or more virtual objects over the persistent connection, wherein the one or more events indicate that the one or more other requests were initiated earlier in time than the one or more requests processed to interact with the one or more virtual objects; and
updating, via the augmented reality application, the augmented reality displayed on the mobile device to reflect the one or more other requests that were initiated prior in time in lieu of the one or more requests processed to interact with the one or more virtual objects.

39. The method of claim 23, further comprising:
zooming out on the one or more images that represent the physical surroundings associated with the mobile device to represent a larger geographic area;
receiving, at the mobile device, data associated with multiple virtual objects having locations in the larger geographic area represented in the one or more images from the augmented reality server; and
forming, via the augmented reality application, one or more clusters to contain the multiple virtual objects in response to the locations associated therewith having a predetermined proximity to one another, wherein the one or more clusters indicate a number of the multiple virtual objects contained therein.

40. The method of claim 39, further comprising displaying, on the mobile device, a list that identifies the multiple virtual objects in the one or more clusters in response to a selection associated with the one or more clusters, wherein the one or more requests relate to one of the multiple virtual objects selected from the displayed list.

41. The method of claim 23, wherein processing the one or more requests includes using the augmented reality application to post comments relating to the one or more virtual objects on the augmented reality server.

42. The method of claim 23, wherein the one or more virtual objects superimposed over the one or more images in the augmented reality have three-dimensional shapes and custom designs, images, or photographs wrapped around surfaces associated therewith, and wherein movements associated with the mobile device cause the displayed augmented reality to show the one or more virtual objects from different perspectives.

43. The method of claim 23, wherein the mobile device comprises a smartphone, augmented reality glasses, augmented reality contact lenses, a head-mounted display, or augmented reality technology directly tied to a human brain.

44. The method of claim 23, further comprising communicating criteria to restrict or control access to the one or more virtual objects from the augmented reality application to the augmented reality server.

45. A computer-readable storage medium storing computer-readable instructions for interacting with virtual objects in augmented realities, wherein executing the computer-readable instructions on a mobile device causes the mobile device to:
use one or more location sensors on the mobile device to determine a location associated with the mobile device;
communicate the location associated with the mobile device to an augmented reality server, wherein the augmented reality server correlates the location associated with the mobile device to one or more virtual objects;
receive, from the augmented reality server, data associated with the one or more virtual objects correlated to the location associated with the mobile device, wherein the data associated with the one or more virtual objects includes locations associated with the one or more virtual objects;
display an augmented reality that superimposes the one or more virtual objects over one or more images that represent physical surroundings associated with the mobile device, wherein the one or more virtual objects are superimposed over the one or more images at the locations associated with the one or more virtual objects; and
process one or more requests to interact with the one or more virtual objects in the augmented reality using an augmented reality application.

46. The computer-readable storage medium of claim 45, wherein the one or more images that represent the physical surroundings associated with the mobile device include a map associated with a physical area that encompasses the location associated with the mobile device.

47. The computer-readable storage medium of claim 45, wherein the one or more images that represent the physical surroundings associated with the mobile device include a satellite view associated with a physical area that encompasses the location associated with the mobile device.

48. The computer-readable storage medium of claim 45, wherein executing the computer-readable instructions on the mobile device further causes the mobile device to use a camera on the mobile device to sense the physical surroundings associated with the mobile device, wherein the physical surroundings sensed with the camera represents a current viewpoint associated with the mobile device.

49. The computer-readable storage medium of claim 48, wherein executing the computer-readable instructions on the mobile device further causes the mobile device to:
use the one or more location sensors to obtain a position and an orientation associated with the mobile device; and
communicate the position and the orientation associated with the mobile device to the augmented reality server, wherein the augmented reality server correlates the position and the orientation associated with the mobile device to the location associated with the mobile device to map the current viewpoint associated with the mobile device.

50. The computer-readable storage medium of claim 48, wherein the one or more images that represent the physical surroundings associated with the mobile device include a map associated with a physical area that encompasses the location associated with the mobile device and the current viewpoint associated with the mobile device.

51. The computer-readable storage medium of claim 45, wherein the one or more requests cause the augmented reality application to collect the one or more virtual objects, destroy the one or more virtual objects, or move the one or more virtual objects to new locations if the locations associated therewith are substantially near to the location associated with the mobile device.

52. The computer-readable storage medium of claim 45, wherein the one or more requests cause the augmented reality application to obtain content or virtual items embedded in the one or more virtual objects from the augmented reality server or upload content or virtual items to embed in the one or more virtual objects to the augmented reality server if the locations associated therewith are substantially near to the location associated with the mobile device.

53. The computer-readable storage medium of claim 52, wherein the content or virtual items obtained from the augmented reality server and the content or virtual items uploaded to the augmented reality server includes text, pictures, graphics, audio, video, icons, games, software, incentive, or advertising content associated with the one or more virtual objects.

54. The computer-readable storage medium of claim 45, wherein the physical surroundings associated with the mobile device include a virtual field and the one or more virtual objects superimposed over the one or more images in the augmented reality include a three-dimensional virtual ball and a three-dimensional virtual goal, and wherein the one or more requests relate to playing an interactive game in which gestures associated with the mobile device cause the three-dimensional virtual ball to move within the virtual field, goals are scored if the gestures cause the three-dimensional virtual ball to enter the three-dimensional virtual goal, and the displayed augmented reality includes a virtual scoreboard to track information relating to the interactive game.

55. The computer-readable storage medium of claim 54, wherein the gestures associated with the mobile device cause the three-dimensional virtual ball to move to a new location within the virtual field based on a current direction, elevation angle, and speed associated with the gestures at a time when the location associated with the mobile device and the location associated with the three-dimensional virtual ball are within a predetermined proximity.

56. The computer-readable storage medium of claim 54, wherein the virtual field comprises a virtual space that overlays a first physical space where one or more players on a first team in the interactive game are located with a second physical space where one or more players on a second team in the interactive game are located.

57. The computer-readable storage medium of claim 54, wherein executing the computer-readable instructions on the mobile device further causes the mobile device to communicate with the augmented reality server over a persistent connection using low-latency communication technology to synchronize the one or more requests that relate to playing the interactive game in substantially real-time.

58. The computer-readable storage medium of claim 45, wherein executing the computer-readable instructions on the mobile device further causes the mobile device to manage, via the augmented reality application, a treasure or scavenger hunt in which multiple users are given clues to describe the locations associated with the one or more virtual objects in a predetermined sequence and subsequent virtual objects in the predetermined sequence only become visible to the multiple users upon collecting prior prerequisite virtual objects in the predetermined sequence.

59. The computer-readable storage medium of claim 45, wherein executing the computer-readable instructions on the mobile device further causes the mobile device to communicate with the augmented reality server over a persistent connection using low-latency communication technology to synchronize the one or more requests to interact with the one or more virtual objects with one or more other requests that one or more other mobile devices initiate to interact with the one or more virtual objects in substantially real-time.

60. The computer-readable storage medium of claim 59, wherein executing the computer-readable instructions on the mobile device further causes the mobile device to:
receive one or more events from the augmented reality server that relate to the one or more other requests that the one or more other mobile devices initiated to interact with the one or more virtual objects over the persistent connection, wherein the one or more events indicate that the one or more other requests were initiated earlier in time than the one or more requests processed to interact with the one or more virtual objects; and
update the displayed augmented reality to reflect the one or more other requests that were initiated prior in time in lieu of the one or more requests processed to interact with the one or more virtual objects.

61. The computer-readable storage medium of claim 45, wherein executing the computer-readable instructions on the mobile device further causes the mobile device to:
zoom out on the one or more images that represent the physical surroundings associated with the mobile device to represent a larger geographic area;
receive, from the augmented reality server, data associated with multiple virtual objects having locations in the larger geographic area represented in the one or more images; and
form one or more clusters to contain the multiple virtual objects in response to the locations associated therewith having a predetermined proximity to one another, wherein the one or more clusters indicate a number of the multiple virtual objects contained therein.

62. The computer-readable storage medium of claim 61, wherein executing the computer-readable instructions on the mobile device further causes the mobile device to display a list that identifies the multiple virtual objects in the one or more clusters in response to a selection associated with the one or more clusters, wherein the one or more requests relate to one of the multiple virtual objects selected from the displayed list.

63. The computer-readable storage medium of claim 45, wherein the one or more requests cause the augmented reality application to post comments relating to the one or more virtual objects on the augmented reality server.

64. The computer-readable storage medium of claim 45, wherein the one or more virtual objects superimposed over the one or more images in the augmented reality have three-dimensional shapes and custom designs, images, or photographs wrapped around surfaces associated therewith, and wherein executing the computer-readable instructions on the mobile device further causes the mobile device to update the displayed augmented reality to show the one or more virtual objects from different perspectives based on movements associated with the mobile device.

65. The computer-readable storage medium of claim 45, wherein the mobile device comprises a smartphone, augmented reality glasses, augmented reality contact lenses, a head-mounted display, or augmented reality technology directly tied to a human brain.

66. The computer-readable storage medium of claim 45, wherein executing the computer-readable instructions on the mobile device further causes the mobile device to communicate criteria to restrict or control access to the one or more virtual objects to the augmented reality server.
